(19) United States
(12) Patent Application Publication
(10) Pub. No.: US 2005/0151947 A1
(43) Pub. Date: Jul. 14, 2005

(54) Position measuring method, position control method, exposure method and exposure apparatus, and device manufacturing method

(75) Inventor: Norihiko Fujimaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Tokyo (JP)

(21) Appl. No.: 11/045,161

(22) Filed: Jan. 31, 2005

Related U.S. Application Data
(63) Continuation of application No. PCT/JP03/09691, filed on Jul. 30, 2003.

(30) Foreign Application Priority Data
Jul. 31, 2002 (JP) 2002-223252

(51) Int. Cl. G03B 27/52

(52) U.S. Cl. 355/55; 355/53

(57) ABSTRACT

Positional information on the scanning direction and non-scanning direction of a reticle stage is measured, based on each of the measurement results of a reticle Y interferometer and a reticle X interferometer. Positional information of a wafer stage is also measured, based on measurement results of a wafer interferometer. Then, based on the measurement results of positional information on the non-scanning direction of the reticle stage, and on correlation information that denotes a relation between position measurement errors of reference points on the reflection surfaces stored in advance and the position of the reticle stage in the non-scanning direction corresponding to the position measurement errors, the positional information of the reticle stage whose measurement errors by the reticle Y interferometer have been corrected is obtained, and thus both stages are driven and controlled based on the corrected positional information and the positional information on the scanning direction-of the wafer sage.

### CROSS-REFERENCE TO RELATED APPLICATIONS

This is a continuation of International Application PCT/JP2003/009691, with an international filing date of Jul. 30, 2003, the entire content of which being hereby incorporated herein by reference, which was not published in English.

### BACKGOUND OF THE INVENTION

1. Field of the Invention

The present invention relates to position measuring methods, position control methods, exposure methods and exposure apparatus, and device manufacturing methods, and more particularly to a position measuring method that measures positional information in at least one axis direction of a moving body which has a reflection surface, using a light wave interference length-measuring instrument such as a laser interferometer, a position control method that uses the measuring method, an exposure method that uses the position control method and an exposure apparatus that can preferably perform the exposure method and the position measuring method, and a device manufacturing method that uses such an exposure method or an exposure apparatus.

2. Description of the Related Art

In a lithographic process to produce electronic devices such as a semiconductor (integrated circuit) or a liquid crystal display device, exposure apparatuses are used that transfer patterns formed on masks or reticles (hereinafter generally referred to as a ‘reticle’) onto wafers or glass plates (hereinafter appropriately referred to as a ‘wafer’) via projection optical systems. And, as such exposure apparatuses, a static type projection exposure apparatus such as the so-called stepper and a scanning type projection exposure apparatus such as the so-called scanning stepper are mainly used.

Especially with the scanning projection exposure apparatus, not only does the wafer stage on which a wafer is mounted have to be moved, but the reticle stage on which a reticle is mounted also has to be moved largely in a predetermined scanning direction. Therefore, in most of the scanning exposure apparatuses, laser interferometers of a light wave interference length-measuring instrument type that have high measurement precisions are used as the measuring unit for measuring the position of the reticle stage in the scanning direction and the non-scanning direction. In addition, because the position measuring accuracy of the reticle stage in the scanning direction greatly affects the overlay accuracy and the synchronization accuracy of the wafer and the reticle, in the recent scanning projection exposure apparatuses, from the viewpoint of preventing the position measuring accuracy from degradation caused by a rotational error of the reticle stage or the like, a comparative number employs the retroreflector as the movable mirror of the laser interferometer whose degradation of measuring accuracy due to a type of the so-called Abbe error, which is caused by the formation precision of the reflection surface or the rotational error of the reticle stage, is sufficiently small when compared with a flat movable mirror. This is because since the retroreflector emits reflection beams along the axis parallel to the incident optical axis, it dramatically reduces the chance for the light quantity of the returning beams to be reduced due to the influence of the residual rotational error of the reticle stage.

The laser interferometers that comprise such kind of movable mirrors can perform position measuring of the moving body at a resolution of around 0.5 to 1 nm.

However, circuit patterns are becoming finer every year due to higher integration of semiconductor devices (integrated circuits), and for this reason, the total overlay error allowed to recent exposure apparatuses is extremely small, which provokes a requirement to suppress position measurement errors of the reticle stage at an even smaller level.

After extensive research, the inventor found out that the deviation of the optical axis of the measurement beam (measurement optical axis) to the optical axis of the reference beam (reference optical axis) of the laser interferometer, which went unnoticed in the past, could be a major cause of measurement errors, and that such a deviation in the optical axis occurs even when the reflection surface of the movable mirror is attached in an ideal state and that it furthermore changes according to the position of the reticle stage. Below is a detailed description of the research.

a. The reason that the deviation of the measurement optical axis to the reference optical axis could be a major cause is because the reference beam and the measurement beam of the laser interferometer usually have wavefront aberration.

That is, as is shown in FIG. 9A, although reference beam Ra (its optical axis is the reference optical axis) and measurement beam Ma (its optical axis is the measurement optical axis) both have wavelength aberration, the reference state is to be a state where there is no optical axis deviation between both beams. And, when deviation of the measurement optical axis to the reference optical axis occurs as is shown in FIG. 9B, the interference section of both beams Ra and Ma (this section decides the measurement results) becomes relatively small, as is obvious when comparing width WD2 (<WD1) with width WD1 in FIG. 9A. As a result, as it can be seen when comparing deviation amount ΔL1 in FIG. 9A and deviation amount ΔL2 (<ΔL1) in FIG. 9B, when looking at the interference section, the positional relation of the wavefront between both beams Ra and Ma is obviously different from the reference state described above, causing measurement error δL (=ΔL1−ΔL2) Wavefront aberration occurs in the reference beam and the measurement beam of the interferometer when these beams transmit glass (a light-transmitting optical element such as a lens) or are reflected off a glass surface (a light-reflecting optical element such as a mirror) on the optical path. And, also in the case wavefront aberration occurs due to relative inclination of the reference beam and the measurement beam, a measurement error occurs, which is similar to the case described above when wavefront aberration can be confirmed.

b. Next, the cause of such optical axis deviation will be described. More specifically, the case will be considered of a state (reference state) where the position of the direction (also referred to as the measurement orthogonal direction) orthogonal to the measurement direction of the moving body (such as the reticle stage) is at a predetermined position, and as is shown in FIG. 10A, the optical axis of the measurement beam (measurement optical axis) Ma irradiated on a movable mirror 15y₁ precisely overlaps the optical axis of the reference beam (reference optical axis) Ra irradiated on a reference mirror 14y₁. From the state shown in FIG. 10A, when the moving body moves in the measurement orthogonal direction by the amount Δ (the moving amount of the tip of movable mirror 15 y₁ is also Δ) and moves into the state shown in FIG. 10B, the optical axis of the measurement beam (measurement optical axis) Ma deviates by 2Δ from the reference state shown in FIG. 10A. In this case, deviation amount 2Δ obviously changes according to the position of the moving body in the measurement orthogonal direction.

In addition, although it is omitted in the drawings, the case will be considered of an interferometer by the so-called double-pass method whose measurement beam enters the retroreflector or the like and the outgoing beam is reflected off a reflection mirror so that the returning light of the reflected beam is turned back along the same optical path in the opposite direction and is received by the interferometer. In such a case, when the reflection mirror attached is inclined, when an optical axis deviation occurs due to the position of the moving body changing as in the earlier description, because the position of the incident point (reflection point) of the measurement beam on the reflection mirror in the measurement direction changes from the reference state, measurement errors occur regardless of the presence of the wavefront aberration in the beams.

As is described above, measurement errors occur due to interaction of the wavefront aberration of the beams and the overlay condition of the beams (hereinafter referred to as a ‘walk-off’), however, measurement errors caused by such factors were completely out of consideration in the past.

In addition, the inventor confirmed that the wavefront aberration and the walk-off amount described above both have high reproducibility.

### SUMMARY OF THE INVENTION

The present invention was made based on the new findings described above, and has as its first object to provide a position measuring method that can measure positional information with good precision in at least one axis direction of a moving body which has a reflection surface, using a light wave interference length-measuring instrument.

The second object of the present invention is to provide a position control method that controls the position of the moving body whose positional information in at least one axis direction is measured with good precision using the light wave interference length-measuring instrument.

The third object of the present invention is to provide an exposure method that achieves exposure with high precision by the scanning exposure method.

The fourth object of the present invention is to provide an exposure apparatus that achieves exposure with high precision by the scanning exposure method.

And, the fifth object of the present invention is to provide a device manufacturing method that can improve the productivity when manufacturing such devices.

According to the first aspect of the present invention, there is provided a position measuring method of measuring positional information on at least an axial direction of a moving body that has a reflection surface using a light wave interference length-measuring instrument, the method comprising: a process in which positional information on a first axis direction of the moving body is measured, based on an output of the light wave interference length-measuring instrument that receives reflection beams of measurement beams irradiated on the reflection surface, and positional information on a second axis direction orthogonal to the first axis of the moving body is measured using a second axis direction position measuring unit; and a process in which measurement errors in the positional information on the first axis direction of the moving body by the light wave interference length-measuring instrument are calculated, based on correlation information, which denotes a relation between position measurement errors of a reference point on the reflection surface and the position related to the second axis direction of the moving body corresponding to the position measurement errors, the errors being caused at least by a positional relation between an optical axis of measurement beams and an optical axis of reference beams of the light wave interference length-measuring instrument, and on positional information on the second axis direction of the moving body that has been measured.

According to this method, on measuring the position of the moving body, the positional information on the first axis direction of the moving body is measured, based on the output of light wave interference length-measuring instrument, which receives the reflection beams of the measurement beams irradiated on the reflection surface of the moving body, and the positional information on the second axis direction orthogonal to the first axis of the moving body is also measured, using the second axis direction position measuring unit. Then, the measurement errors in the positional information on the first axis direction of the moving body by the light wave interference length-measuring instrument are calculated, based on correlation information, which denotes a relation between position measurement errors of a reference point on the reflection surface and the position of the moving body related to the second axis direction corresponding to the position measurement errors. The position measurement errors are caused at least by a positional relation between an optical axis of measurement beams and an optical axis of reference beams of the light wave interference length-measuring instrument. This allows the positional information of the moving body measured in the first axis direction based on the output of light wave interference length-measuring instrument, to be corrected using the measurement errors, which makes it possible to obtain the positional information on the first axis direction of the moving body measured whose measurement errors have been corrected. That is, the positional information can be obtained whose position measurement errors of the moving body in the first axis direction due to the optical axis deviation of the light wave interference length-measuring instrument is corrected according to the position of the moving body in the second axis direction. Accordingly, the positional information on at least one axial direction of the moving body on which the reflection surface is provided can be measured with good precision.

In this case, the method can further comprise: a process performed prior to the process of measuring positional information, in which while the position of the moving body in the first axis direction is detected based on the output of the light wave interference length-measuring instrument that receives reflection beams of measurement beams irradiated on the reflection surface, the moving body is moved in the second axis direction using the second axis direction position measuring unit, position measurement errors of the reference point on the reflection surface are obtained at each of a plurality of positions in the second axis direction, and the correlation information is made based on the position measurement errors obtained at each of the plurality of positions.

In this case, various ways can be considered to obtain the position measurement errors of the reference point on the reflection surface. For example, the position measurement errors of the reference point on the reflection surface can be calculated by a predetermined calculation, based on a deviation amount of a measurement optical axis of the light wave interference length-measuring instrument to a reference optical axis and the positional information on the second axis direction of the moving body. However, when considering the point that the walk off amount of the beam has a high reproducibility, the position measurement errors of the reference point on the reflection surface can also be obtained, based on measurement results of measuring a positional relation between measurement marks provided in a part of the moving body and fiducial marks provided on a fiducial object.

In the position measuring method of the present invention, in the case the process prior to the measuring process includes a process of making the correlation information, the correlation information can be function data calculated based on each plot point data, which are the position measurement errors of the reference point on the reflection surface obtained at each of the positions in the second axis direction, plotted on a predetermined coordinate system, or the correlation information can also be a table data made using the position measurement errors of the reference point on the reflection surface obtained at each of the positions in the second axis direction.

In the position measuring method of the present invention, in the case the process prior to the measuring process includes a process of making the correlation information, in the process of calculating measurement errors, the errors can be calculated using calculation results that are interpolated by a predetermined interpolation calculation of the position measurement errors at each of the plurality of positions in the second axis direction in the correlation information, according to the positional information on the second axis direction of the moving body that has been measured.

In the position measuring method of the present invention, in the case the process prior to the measuring process includes a process of making the correlation information, in the process of making the correlation information, the moving body can be moved in the second axis direction while substantially maintaining the position of the moving body in the first axis direction at a predetermined coordinate position based on the output of the light wave interference length-measuring instrument.

In the position measuring method of the present invention, in the process of calculating measurement errors, the measurement errors can be calculated with further consideration of attitude of the moving body. The attitude of the moving body includes at least either one of yawing, rolling, or pitching of the moving body.

In the position measuring method of the present invention, the position measurement errors included in the correlation information can further be caused by wavefront aberration generated in the measurement beams. In the description, besides when the wavefront aberration is generated when the measurement beam passes through the optical elements arranged on the optical path or when the measurement beam is reflected off the optical elements, it also is to include the case when wavefront aberration is generated when the measurement beam is relatively inclined with respect to the reference beam.

In the position measuring method of the present invention, as the reflection surface, prisms or other reflection surface may be used, or, the reflection surface can also be a reflection surface of a hollow retroreflector fixed to the moving body.

In the position measuring method of the present invention, the method can further comprise: a process in which positional information of the moving body in the first axis direction whose the measurement error have been corrected is calculated.

According to the second aspect of the present invention, there is provided a position control method of controlling the position of a moving body whose position is measured in at least an axial direction using a light wave interference length-measuring instrument, the method comprising: a position measuring process in which the position measuring method of the present invention is performed to measure positional information on the first axis direction of the moving body; and a process in which at least position of the moving body in the first axis direction is controlled, taking into consideration information obtained in the position measuring process.

According to this method, because the positional information on the first axis direction of the moving body is measured performing the position measuring method of the present invention, the positional information on the first axis direction of the moving body can be measured with good precision using the light wave interference length-measuring instrument. And, because the positional information on at least one axial direction (the first axis direction) controls the position of the moving body in the first axis direction by with the light wave interference length-measuring instrument, based on the positional information measured with good precision, the position of the moving body can be controlled with high precision.

According to the third aspect of the present invention, there is provided an exposure method of transferring a pattern formed on a mask onto a photosensitive object by synchronously moving the mask and the photosensitive object in a predetermined direction, wherein positional information on the predetermined direction of at least one of a first moving body on which the mask is mounted and a second moving body on which the photosensitive object is mounted is measured, using the position measuring method in the present invention, and transfer of the pattern onto the photosensitive object is performed by controlling position of at least one of the first moving body and the second moving body in the predetermined direction, taking into consideration information obtained by results of the measurement.

According to this method, the positional information on the predetermined direction (synchronous moving direction) of at least either the first moving body on which the mask is mounted or the second moving body on which the photosensitive object is mounted is measured, using the position measuring method of the present invention. Then, the position of at least either the first moving body or the second moving body (for example, the trailing moving body on synchronous movement) in the predetermined direction is controlled, taking into consideration the information obtained from the results of the measurement, and pattern transfer onto the photosensitive object is performed. Accordingly, by the position control described above, the synchronization accuracy of the first moving body and the second moving body, that is, the mask and the photosensitive object, can be improved, and the synchronization settling time reduced, which in turn makes it possible to achieve exposure with high precision by the scanning exposure method, and the pattern of the mask can be transferred onto the photosensitive object with good precision.

According to the fourth aspect of the present invention, there is provided a first exposure apparatus that synchronously moves a mask and photosensitive object in a predetermined scanning direction and transfers a pattern formed on the mask onto the photosensitive object, the apparatus comprising: a first stage on which the mask is mounted and a reflection surface provided; a second stage on which the photosensitive object is mounted; a drive system that drives the first stage and the second stage; a first measuring system that has a light wave interference length-measuring instrument, which irradiates a measurement beam on the reflection surface and measures positional information on the scanning direction of the first stage, and a measuring unit, which measures positional information on a non-scanning direction orthogonal to the scanning direction of the first stage; a second measuring system that measures positional information on at least the scanning direction of the second stage; and a control unit that controls the drive system, based on measurement results of the first measuring system and the second measuring system, and on correlation information, which denotes a relation between position measurement errors of a reference point on the reflection surface and the position related to the non-scanning direction of the first stage corresponding to the position measurement errors, the errors being caused at least by a positional relation between an optical axis of measurement beams and an optical axis of reference beams of the light wave interference length-measuring instrument.

According to this apparatus, the first measuring system irradiates a measurement beam from the light wave interference length-measuring instrument on the reflection surface provided on the first stage and measures the positional information on the scanning direction of the first stage, as well as measure the positional information on the non-scanning direction of the first stage, using the measuring unit. Meanwhile, the second measuring system measures the positional information on at least the scanning direction of the second stage. Then, the control unit controls the drives system, based on measurement results of the first measuring system and the second measuring system, and on correlation information, which denotes the relation between position measurement errors of the reference point on the reflection surface and the position of the first stage related to the non-scanning direction corresponding to the position measurement errors, the errors being caused at least by the positional relation between the optical axis of measurement beams and the optical axis of reference beams of the light wave interference length-measuring instrument. That is, the control unit synchronously controls the first stage and eth second stage, or in other words, synchronously controls the mask and the photosensitive object with good precision via the drive system, taking into consideration the position measurement errors of the first stage in the scanning direction caused by the optical axis deviation of the light wave interference length-measuring instrument (deviation of the optical axis of the measurement beam to the optical axis of the reference beam) corresponding to the position of the first stage in the non-scanning direction. This allows the synchronization accuracy of the mask and the photosensitive object to be improved, and the synchronization settling time reduced, which in turn makes it possible to achieve exposure with high precision by the scanning exposure method, and the pattern of the mask can be transferred onto the photosensitive object with good precision.

In this case, the control unit can correct relative positional errors of the mask and the photosensitive object in the scanning direction caused by measurement errors of the first stage by the light wave interference length-measuring instrument, using the correlation information and the positional information on the non-scanning direction of the first stage.

In the first exposure apparatus of the present invention, the control unit can calculate information on measurement errors of the first stage by the light wave interference length-measuring instrument, based on the correlation information and the positional information on the non-scanning direction of the first stage, and uses the calculated information when moving the first stage in the scanning direction. Or, the control unit can also calculate positional information on the scanning direction of the first stage whose measurement errors by the light wave interference length-measuring instrument have been corrected, based on the correlation information and the positional information on the non-scanning direction of the first stage, and uses the calculated information when moving the first stage in the scanning direction.

In the first exposure apparatus of the present invention, the correlation information can be made in advance, based on the position measurement errors of a reference point on the reflection surface obtained at each of a plurality of positions in the non-scanning direction by the control unit, which moves the first stage in the non-scanning direction via the drive system while detecting the position of the first stage in the scanning direction based on an output of the light wave interference length-measuring instrument.

In this case, the control unit can control the first stage via the drive system when making the correlation information, and also can have a storage unit that stores the correlation information that has been made.

In the first exposure apparatus of the present invention, in the case the apparatus further comprises: a mark measuring system that measures a positional relation between measurement marks provided on a part of the first stage and fiducial marks provided on a reference object, the correlation information can be made in advance based on the position measurement errors of a reference point on the reflection surface, which are obtained based on measurement results of the mark measuring system.

In the first exposure apparatus of the present invention, the correlation information can be a table data made using the position measurement errors of the reference point on the reflection surface obtained at each of the positions in the non-scanning direction.

In this case, the measurement errors by the light wave interference length-measuring instrument can be calculated using calculation results that are interpolated by a predetermined interpolation calculation of the position measurement errors at each of the plurality of positions in the non-scanning direction in the correlation information, according to positional information on the non-scanning direction of the first stage that has been measured.

In the first exposure apparatus of the present invention, the correlation information can be function data calculated based each plot point data, which are the position measurement errors of the reference point on the reflection surface obtained at each of the positions in the non-scanning direction, plotted on a predetermined coordinate system.

In the first exposure apparatus of the present invention, when making the correlation information, the control unit can move the first stage in the non-scanning direction, while substantially maintaining the position of the first stage in the scanning direction at a predetermined position based on the output of the light wave interference length-measuring instrument.

In the first exposure apparatus of the present invention, the control unit can calculate the position measurement errors with further consideration of attitude of the first stage.

In the first exposure apparatus of the present invention, the position measurement errors included in the correlation information can be further caused by wavefront aberration generated in the measurement beams.

In the first exposure apparatus of the present invention, the reflection surface can be a reflection surface of a hollow retroreflector.

According to the fifth aspect of the present invention, there is provided a second exposure apparatus that synchronously moves a first object and a second object and transfers a pattern of the first object onto the second object, the apparatus comprising: a stage system that has a first movable body that holds the first object, a second movable body that holds the second object, and a drive system that drives the first movable body and the second movable body independently; a first interferometer system that irradiates a measurement beam onto a retroreflector provided in the first movable body and measures positional information on a scanning direction of the first movable body in which the first object is synchronously moved; a second interferometer system that measures positional information of the second movable body; and a control unit that controls the drive system based on measurement results of the first interferometer system and the second interferometer system, and on error information on position measurement of the first movable body due to the retroreflector.

According to this apparatus, the control unit controls the drive system based on the measurement results of the first interferometer system and the second interferometer system, and on error information on position measurement of the first movable body due to the retroreflector (for example, error information on position measurement of the first movable body due to the optical axis deviation of the measurement beam optical axis to the reference optical axis occurring due to the positional change of the retroreflector in the direction orthogonal to the measuring direction). That is, the control unit performs synchronous control of the first movable body and second movable body with good precision via the drive system, taking into consideration the error information on position measurement of the first movable body due to the retroreflector. This allows the synchronization accuracy of the first object and the second object to be improved, and the synchronization settling time reduced, which in turn makes it possible to achieve exposure with high precision by the scanning exposure method, and the pattern of the first object can be transferred onto the second object with good precision.

In this case, the control unit can control the drive system using different error information according to the position of the first movable body in a non-scanning direction orthogonal to the scanning direction.

In addition, in the lithographic process, by transferring a microdevice pattern onto a photosensitive object using the exposure method of the present invention, the pattern can be formed with good precision on the photosensitive object, which makes it possible to produce microdevices of higher integration with good yield. In addition, in the lithographic process, by performing exposure using either one of the first or second exposure apparatus of the present invention, the pattern can be transferred with good precision onto the photosensitive object, which allows production of microdevices of higher integration with good yield. Accordingly, further from another aspect of the present invention, it can be said that the present invention is a device manufacturing method that uses the exposure method of the present invention, and one of the first or second exposure apparatus of the present invention.

### BRIEF DESCRIPTON OF THE DRAWINGS

In the accompanying drawings;

FIG. 1 is a view of an entire structure of an exposure apparatus related to an embodiment in the present invention;

FIG. 2 is a perspective view of components extracted from FIG. 1, such as a reticle stage, a reticle interferometer that measures the position of the reticle stage, a reticle alignment system that performs synchronous measurement of marks on a reticle R or on a reticle fiducial plate RFM and fiducial marks on a fiducial mark plate FM, and the like;

FIG. 3A is a planar view of an arrangement of fiducial marks WM₁ and WM₂ on fiducial mark plate FM, and FIG. 3B is a planar view of an arrangement of measurement marks on reticle fiducial plate RFM;

FIG. 4 is a flow chart of a processing algorithm of a main control unit (the CPU inside) when correlation information for correcting measurement errors of a reticle Y interferometer is made;

FIGS. 5A, SC, 5E, 5G, and 5I are views of mark imaged measured by one of the reticle alignment systems RA₁ and measurement errors of one of the reticle Y interferometers obtained based on the images, and FIGS. 5B, SD, 5F, 5H, and 5J are views of mark imaged measured by the other reticle alignment system RA₂ and measurement errors of the other reticle Y interferometer obtained based on the images;

FIG. 6A is a view of a plurality of point corresponding to measurement errors of one of the reticle Y interferometers, plotted on an orthogonal coordinate system, and FIG. 6B a view of a plurality of point corresponding to measurement errors of the other reticle Y interferometer, plotted on an orthogonal coordinate system;

FIG. 7 is a flow chart for explaining an embodiment of a device manufacturing method according to the present invention;

FIG. 8 is a flow chart for showing a detailed example of step 204 in FIG. 7;

FIGS. 9A and 9B are views for explaining the principle of why measurement errors occur due to reciprocal action of an optical axis deviation between a reference beam and a measurement beam and wavefront aberration; and

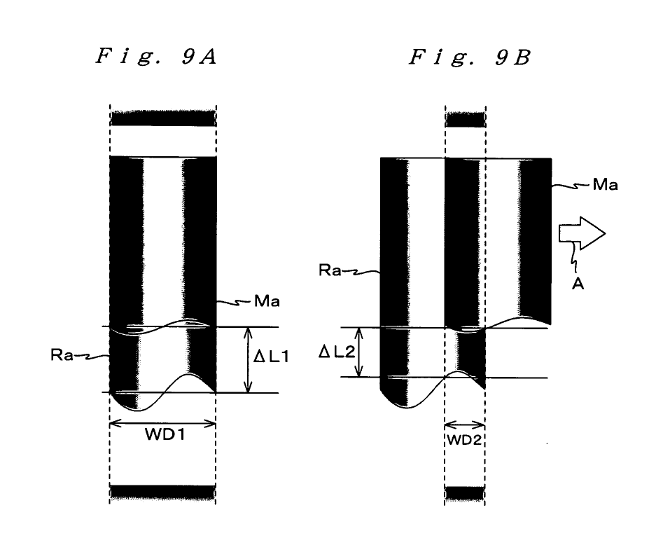

FIGS. 10A and 10B are views for explaining the principle of why the optical axis deviation between the reference beam and the measurement beam occurs by the movement of a movable mirror (moving body) moving in a direction orthogonal to the measuring direction.

### DESCRIPTION OF THE EMBODIMENTS

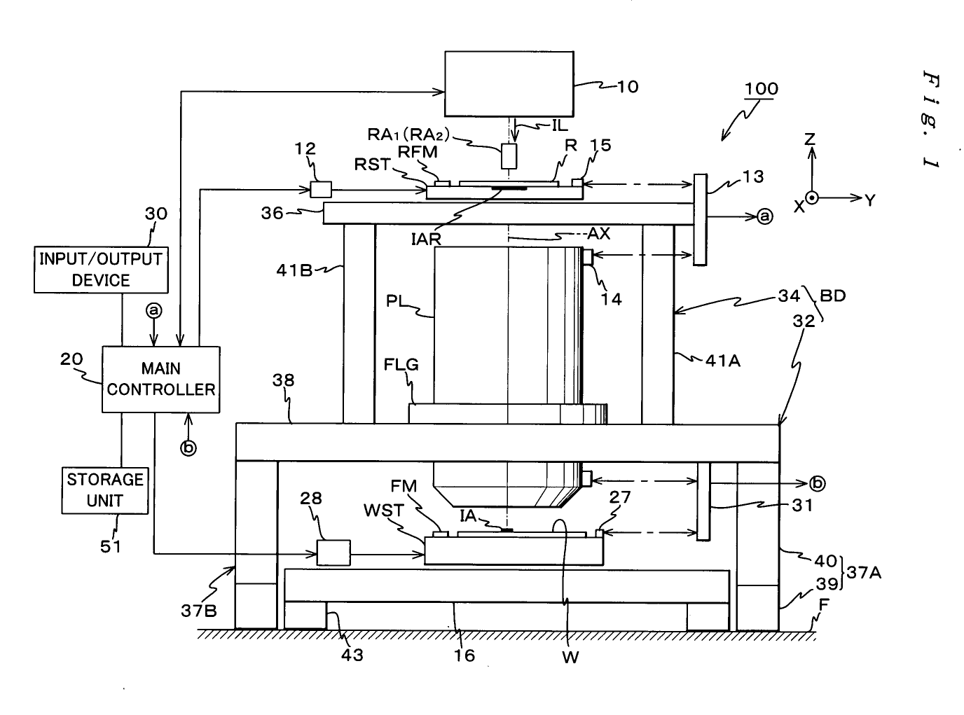

An embodiment of the present invention is described below, referring to FIGS. 1 to 6B. FIG. 1 is an entire view of an arrangement of an exposure apparatus 100 related to an embodiment to which the position measuring method, the position control method, and the exposure method of the present invention can be suitably applied. Exposure apparatus 100 is a scanning projection exposure apparatus based on a step-and-scan method, that is, the so-called scanning stepper.

Exposure apparatus 100 comprises: an illumination system 10 that includes a light source and an illumination optical system; a reticle stage RST that serves as a first stage (a first moving body, or moving body), which holds a reticle R serving as a mask; a projection optical system PL; a wafer stage WST that serves as a second stage (a second moving body), which can move freely within an XY plane, holding a wafer W serving as a photosensitive object; a body BD on which parts such as projection optical system PL are mounted; and the like.

Illumination system 10 comprises a light source (not shown), and an illumination optical system that includes parts such as a beam shaping optical system, a rough energy adjuster, an optical integrator (such as a fly-eye lens, a rod integrator (an internal reflection type), or a diffractive optical element), an illumination system aperture stop plate, a beam splitter, a relay optical system, a fixed reticle blind, a movable reticle blind (none of which are shown), and the like. Illumination system 10 illuminates an oblong (such as a in a rectangle) slit-shaped illumination area IAR (set by the opening of the fixed reticle blind) that narrowly extends in the X-axis direction on reticle R held on reticle stage RST with uniform illuminance. Details on the arrangement of the illumination system similar to the one employed in the embodiment are disclosed in, for example, Japanese Patent Application Laid-open No.H06-349701 and its corresponding U.S. Pat. No. 5,534,970, as well as in Japanese Patent Application Laid-open No.2000-260682. As long as the national laws in designated states or elected states, to which this international application is applied, permit, the disclosure of U.S. patent cited above is fully incorporated herein by reference.

As the light source, a KrF excimer laser (oscillation wavelength: 248 nm), an ArF excimer laser (oscillation wavelength: 193 nm), an F₂ laser (oscillation wavelength: 157 nm), or the like may be used. The light source is actually arranged in places such as on a floor surface F in a clean room where the main body of the exposure apparatus is arranged, or in a room whose level of cleanliness is lower than that of the clean room (such as a service room), and it connects to the incident end of the illumination optical system via a light guiding optical system (not shown).

Reticle stage RST is supported by levitation with air bearings (not shown) provided on its bottom surface via a clearance, for example, by around several μm, above the upper surface of a reticle base 36, which structures the top panel section of a second column 34 that will be described later. On reticle stage RST, reticle R is fixed, for example, by vacuum chucking (or by electrostatic suction). In this case, reticle stage RST is finely movable two dimensionally (in the X-axis direction, the Y-axis direction, and a rotational direction around a Z-axis orthogonal to an XY plane (the Oz direction)) within an XY plane perpendicular to an optical axis AX of projection optical system PL, which will also be described later, and drivable in the Y-axis direction at a designated scanning speed on reticle base 36, by a reticle stage drive section 12 that includes parts such as a linear motor.

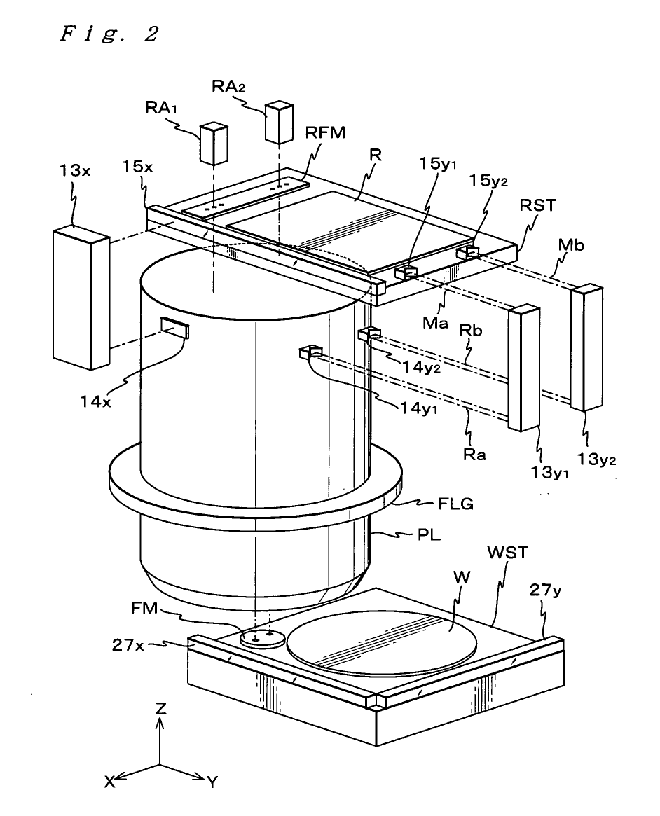

In actual, reticle stage RST is made up of a reticle rough movement stage that can move on reticle base 36 by the linear motor in the Y-axis direction within a predetermined stroke range, and a reticle fine movement stage that can move finely with respect to the reticle rough movement stage in the X-axis direction, the Y-axis direction, and the θz direction by an actuator such as at least three voice coil motors. However, in FIGS. 1 and 2, reticle stage RST is shown as a single stage. Accordingly, in the following description, reticle stage RST will be described as a single stage that can be finely driven in the X-axis direction, the Y-axis direction, and the θz direction as is described above and can also be scanned in the Y-axis direction by reticle stage drive section 12.

The movement strokes of reticle stage RST in the Y-axis direction is large enough so that the total surface of reticle R can at least slide past optical axis AX of projection optical system PL. In the case of this embodiment, the movers of the linear motor are respectively attached to the surface of reticle stage RST on both sides in the X-axis direction (the side near the page surface and the side in the depth in FIG. 1), and the stators corresponding to the movers are each supported by support members (not shown) that are provided apart from body BD. Therefore, the reaction force that acts on the stators of the linear motor when reticle stage RST is driven travels (or is released) to floor surface F of the clean room via the support members. As is previously described, reticle stage drive section 12 includes an actuator such as a linear motor and a voice coil motor, however, in FIG. 1, reticle stage drive section 12 is shown simply as a block for the sake of convenience.

In the embodiment, the reaction frame structure has been employed where reaction force is released via the support member provided separately from body BD, and details on such an arrangement are disclosed in, for example, Japanese Patent Application Laid-open No.H08-330224, and the corresponding U.S. Pat. No. 5,874,820. As long as the national laws in designated states or elected states, to which this international application is applied, permit, the disclosures of the Japanese Patent Application and the U.S. patent cited above are fully incorporated herein by reference.

The arrangement, however, is not limited to the reaction frame structure described above, and the embodiment may also employ a counter mass structure that has counter masses that cancel out the reaction force during the movement of reticle stage RST using the law of conservation of momentum. Details on the reaction force cancel mechanism that uses such law of conservation of momentum are disclosed in, for example, Japanese Patent Application Laid-open No.H08-63231, and the corresponding U.S. Pat. No. 6,255,796. As long as the national laws in designated states or elected states, to which this international application is applied, permit, the disclosures of the Japanese Patent Application and the U.S. patent cited above are fully incorporated herein by reference.

On the end on one side of the Y-axis direction (the +Y side) on the upper surface of reticle stage RST, a movable mirror 15 is fixed that reflects the laser beam from a reticle laser interferometer (hereinafter referred to as a ‘reticle interferometer’) 13 serving as a first measuring system fixed on reticle base 36, and reticle interferometer 13 detects the position of reticle stage RST within the XY plane (including the rotation in the θz direction, which is the rotational direction around the Z-axis) at all times at a resolution of, for example, around 0.5 to 1 nm. In actual, as is shown in FIG. 2, on the upper surface of reticle stage RST on the end on one side of the Y-axis direction (the +Y side), a pair of Y-axis movable mirrors 15y₁ and 15y₂ that are made up of hollow retroreflectors are fixed in the X-axis direction at a predetermined interval, and on the end on one side of the X-axis direction (the +X side), an X-axis movable mirror 15x is fixed, which is made up of a flat mirror that has a reflection surface orthogonal to the X-axis direction. Furthermore, corresponding individually to such movable mirrors 15y₁, 15y₂, and 15x, reticle Y interferometers 13y₁ and 13y₂ consisting of a pair of laser interferometers that serve as a light wave interference length-measuring instrument and a reticle X interferometer 13x that serves as a measuring unit are provided. As is described above, the reticle interferometer and the movable mirror are each provided in plurals, however, in FIG. 1, these are representatively indicated as movable mirror 15 and reticle interferometer 13. In addition, movable mirrors 15x, 15y₁, and 15y₂ are actually provided on the reticle fine movement stage. Incidentally, for example, the end surface on the +X side of reticle stage RST may be mirror polished so as to form a reflection surface (corresponding to the reflection surface of movable mirror 15x).

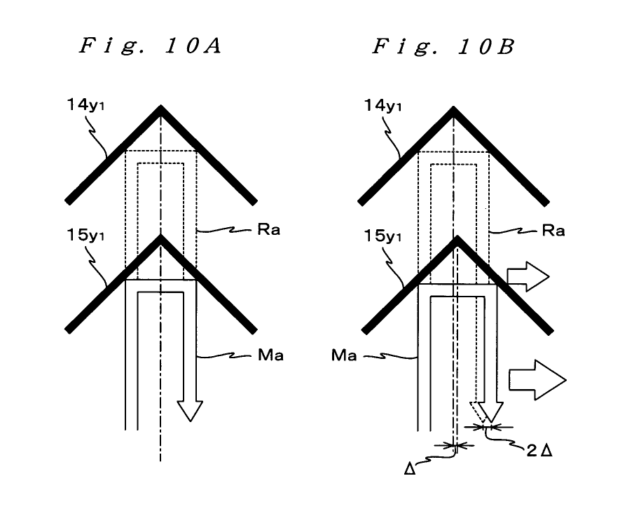

As one of the reticle Y interferometers reticle Y interferometer 13y₁, a single-pass laser interferometer is used. Reticle Y interferometer 13y₁, for example, employs a two-frequency laser that utilizes the Zeeman effect as its light source, and inside the light source a heterodyne laser interferometer that has a polarized beam splitter, a quarter-wave plate, a polarizer, a photoelectric conversion element, and the like is used. The two-frequency laser referred to above, for example, emits laser beams that include two components where the frequencies differ only from two to three MHz and their polarized directions are orthogonal to each other, or to be more specific, a emits a circular beam whose wavelengths differ in the two vertical and horizontal orthogonal polarized components, with the beam having a Gauss distribution. Of such polarized components, the vertical polarized component (V component) passes through a polarized beam splitter and becomes a measurement beam Ma, which passes the measurement pass, whereas the horizontal polarized component (H component) is reflected off the polarized beam splitter and becomes a reference beam Ra, which passes the reference pass. As a matter of course, measurement beam Ma and reference beam Ra are each converted into circular lights when they pass through the quarter-wave plate just before being emitted from interferometer 13y₁. For example, as is also shown in FIG. 10A previously described, measurement beam Ma returns to reticle Y interferometer 13y₁ via the first reflection surface and the second reflection surface of movable mirror 15y₁, and then enters the optical system and the polarizer inside. Meanwhile, as is shown in FIG. 2, reference beam Ra returns to reticle Y interferometer 13y₁ via the first reflection surface and the second reflection surface of a reference mirror 14y₁ made up of a hollow retroreflector fixed to the side surface of the barrel of projection optical system PL, and then enters the optical system and the polarizer inside. In this case, the polarizer is set in a direction where the angle of polarization is 45° with respect to the H component and V component, which allows the returning beams of both components, that is, the interference light of the returning beams of measurement beam Ma and reference beam Ra, to be provided to the photoelectric conversion element. The photoelectric conversion element then photoelectrically converts the interference light of both components, and then provides the electric signals (interference signals) to a signal processing system (not shown). In this case, the phase of the measurement beam Doppler shifts with respect to the phase of the reference beam and a phase change occurs by the movement of movable mirror 15y₁. The signal processing system performs heterodyne detection on the phase difference of the reference beam and the measurement beam, and detects the moving distance of movable mirror 15y₁, that is, the position or the positional change of movable mirror 15y₁ (or to be more precise, the reference point of movable mirror 15y₁, that is, the tip of the hollow retroreflector making up movable mirror 15y₁) with the position of reference mirror 14y₁ as a reference. The signal processing is performed using a well-acknowledged method that relates to the heterodyne interferometer.

As for the other reticle Y interferometer, reticle Y interferometer 13y₂, a structure similar to reticle Y interferometer 13y₁ described above is employed, and a measurement beam Mb and a reference beam Rb from interferometer 13y₂ are respectively irradiated on movable mirror 15y₂ and a reference mirror 14y₂ made up of a hollow retroreflector. Then, the interference signals of such reflection beams (returning beams) are photoelectrically converted by the photoelectric conversion element within reticle Y interferometer 13y₂ in a manner similar to the one described above, and by the signal processing system performing heterodyne detection on the phase difference of the reference beam and the measurement beam, the position or the positional change of movable mirror 15y₂ (or to be more precise, the reference point of movable mirror 15y₂, that is, the tip of the hollow retroreflector making up movable mirror 15y₂) is detected, with the position of reference mirror 14y₂ as a reference.

Accordingly, based on at least either one of the measurement values of reticle Y interferometers 13y₁ and 13y₂ (for example, the average value of both measurement values), the position of reticle stage RST in the Y-axis direction can be measured, and also based on the difference of the measurement values and the distance in between the measurement axes, the rotation of reticle stage RST in the θz direction can be measured (calculated).

In addition, as reticle X interferometer 13x, a heterodyne interferometer is used similar to each of the interferometers 13y₁ and 13y₂ described above. The reference beam and the measurement beam from reticle X interferometer 13x respectively irradiate X movable mirror 15x and a reference mirror 14x made up of a flat mirror shown in FIG. 2, and similar to the description above, the interference signals of such reflection beams (returning beams) are photoelectrically converted by the photoelectric conversion element within reticle X interferometer 13x, and by the signal processing system performing heterodyne detection on the phase difference of the reference beam and the measurement beam, the position or the positional change is detected with the position of reference mirror 14x as a reference. The position of reticle stage RST in the X-axis direction is measured based on the measurement values of reticle X interferometer 13x.

The positional information on reticle stage RST from reticle Y interferometers 13y₁ and 13y₂ and from reticle X interferometer 13x is sent to a main controller 20 where it controls reticle stage RST via reticle stage drive section 12 based on such positional information.

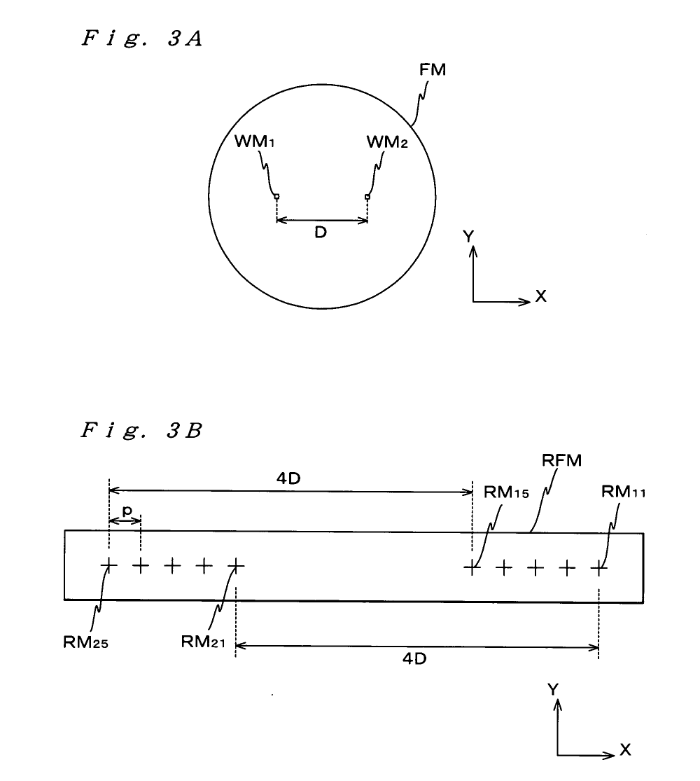

In addition, on the end section of the −Y direction on the upper surface of reticle stage RST, a fixed mark plate made up of the same glass material as the reticle, that is, a reticle fiducial plate (hereinafter referred to as ‘reticle fiducial plate’) RFM is arranged extending in the X-axis direction. As is shown in FIG. 2, on reticle fiducial plate RFM, at a position substantially opposing the pair of Y-axis movable mirrors 15y₁ and 15y₂, a set of fiducial marks of at least three each is formed, arranged in a predetermined pitch in the X-axis direction, respectively. In the embodiment, as is shown in FIG. 3B, for example, five marks each are to be arranged in the areas on the +X side and the −X side of reticle fiducial plate RFM, respectively. To be more specific, measurement marks RM₁₁ to RM₁₅ are arranged in the area on the +X side, and measurement marks RM₂₁ to RM₂₅ are arranged in the area on the −X side. As measurement marks RM₁₁ to RM₁₅ and measurement marks RM₂₁ to RM₂₅, + marks are used. In this case, pitch p in between the fiducial marks is, for example, around 100 μm to 1 mm, and an interval 4D in between measurement marks RM₁₁ and RM₂₁ (i=1 to 5) that reciprocally make a pair is, for example, around 100 to 150 mm.

Projection optical system PL is held by a first column 32 making up body BD, under reticle stage RST as is shown in FIG. 1. The structure of body BD will be described below.

Body BD comprises: the first column 32, which is arranged on floor surface F in the clean room (or the upper surface of the frame); and a second column 34, which is mounted on the upper surface of the first column 32. The first column 32 comprises: three leg sections 37A to 37C (in FIG. 1, however, leg section 37C located in the depth of the page surface is omitted); and a barrel supporting platform 38 whose lower end surface connects to the upper end surface of the three leg sections 37A to 37C, and the platform also making up the ceiling section of the first column 32.

Leg sections 37A to 37C each comprise a vibration isolation unit 39 arranged on the floor surface and a supporting strut fixed on the upper section of vibration isolation unit 39. Each vibration isolation unit insulates fine vibration from floor surface F at a micro-G level, so that the fine vibration substantially does not travel to barrel supporting platform 38. Barrel supporting platform 38 has a circular opening formed in around the center section, and in the opening, projection optical system PL is inserted from above with the direction of its optical axis AX as the Z-axis direction.

On the barrel of projection optical system PL, a flange FLG is provided, and barrel supporting platform 38 supports projection optical system PL via flange FLG. On the upper surface of barrel supporting platform 38 at the position surrounding projection optical system PL, for example, the lower end of three leg sections 41A to 41C (in FIG. 1, however, leg section 41C located in the depth of the page surface is omitted) is fixed, and on the upper section of the three leg sections 41A to 41C, reticle base 36 is mounted and horizontally supported. That is, reticle base 36 and the three leg sections 41A to 41C make up the second column 34.

As projection optical system PL, in this case, is a double telecentric reduction system, which uses a dioptric system that is made up of a plurality of lens elements arranged at a predetermined interval in the direction of optical axis AX. And, as projection optical system PL, a reduction optical system whose projection magnification β is, for example, ¼, is used. Therefore, when illumination system 10 illuminates the slit shaped illumination area IAR on reticle R with illumination light IL, illumination light IL that has passed through reticle R forms a reduced image (partially inverted image) of the circuit pattern within the slit shaped illumination area IAR of reticle R on an exposure area IA, which is formed on wafer W whose surface is coated with a photoresist and is conjugate with illumination area IAR.

Wafer stage WST is actually structured including an XY stage that moves within the XY two-dimensional plane, and a wafer table mounted on the XY stage. In this case, the XY stage is driven freely on the upper surface of a stage base 16 by a drive system (not shown) such as a linear motor or a planar motor, within the XY two-dimensional plane (including the θz rotation).

The wafer table is driven in the direction of optical axis AX (the Z-axis direction) and the direction of inclination with respect to the surface orthogonal to the optical axis (the XY plane), that is, the θx direction, which is the rotational direction around the X-axis, and the θy direction, which is the rotational direction around the Y-axis, by a drive system (not shown) arranged on the XY stage that includes an actuator such as a voice coil motor.

On the wafer table, a wafer holder (not shown) holds wafer W by vacuum chucking (or by electrostatic suction).

As is described above, wafer stage WST is made including a plurality of components, however, in the description below, for the sake of convenience, wafer stage WST is described as a single stage that is driven freely in the X, Y, Z, θx, θy, and θz directions, in directions of six degrees of freedom, by a wafer stage drive section 28, which operates under the control of main controller 20. Although wafer stage drive section 28 includes parts such as a linear motor, a planar motor, and a voice coil motor, in FIG. 1, for the sake of convenience, it is shown simply as a block. In addition, for example, by making wafer table finely drivable in at least the X-axis and Y-axis directions with respect to the XY stage, wafer stage WST may be referred to as a rough/fine movement stage.

Stage base 16 is also called a supporting platform, and in the embodiment, it is arranged on floor surface F via a plurality of vibration isolation tables 43. That is, stage base 16 is structured separately from body BD, which holds parts such as projection optical system PL.

On wafer stage WST (or to be more precise, on the wafer stage), a movable mirror 27 is fixed that reflects the laser beam from a wafer laser interferometer (hereinafter referred to as a ‘wafer interferometer’) 31 serving as a second measuring system, and wafer interferometer 31, which is fixed on body BD, detects the position of wafer stage WST within the XY plane at all times at a resolution of, for example, around 0.5 to 1 nm.

In actual, a movable mirror that has a reflection surface orthogonal to the Y-axis direction, which is the scanning direction on scanning exposure, and a movable mirror that has a reflection surface orthogonal to the X-axis direction, which is the non-scanning direction, are provided on the upper surface of wafer stage WST (or to be more precise, the wafer table described earlier), and corresponding to the mirrors, as the laser interferometer, an X laser interferometer for measuring the position in the X-axis direction and a Y laser interferometer for measuring the position in the Y-axis direction are provided. In FIG. 1, however, these are representatively shown as movable mirror 27 and wafer interferometer 31. Incidentally, for example, the end surface of wafer stage WST may be mirror polished so as to form a reflection surface (corresponding to the reflection surface of movable mirror 27). In addition, the X laser interferometer and the Y laser interferometer are a multi-axis interferometer having a plurality of measurement axes that can measure the X position and Y position of the wafer table, as well as its rotation (yawing (the θz rotation around the Z-axis), pitching (the θx rotation around the X-axis), and rolling (the θy rotation around the Y-axis)). Accordingly, in the following description, wafer interferometer 31 is to measure the position of wafer stage WST in directions of five degrees of freedom, in the X, Y, θx, θy, and θz directions. In addition, the multi-axis interferometer may irradiate a laser beam on the reflection surface (not shown) arranged on body BD where projection optical system PL is mounted via the reflection surface arranged on wafer stage WST inclined at an angle of 45°, and detect relative positional information of projection optical system PL regarding the optical axis direction (the Z-axis direction).

The positional information (or velocity information) on wafer stage WST is sent to main controller 20, and main controller 20 controls wafer stage WST via wafer stage drive section 28, based on such positional information (or velocity information).

On wafer stage WST, a fiducial mark plate FM is fixed. The surface of fiducial mark plate FM is arranged at substantially the same height as surface of wafer W held on wafer stage WST. On the surface of fiducial mark plate FM, a large number of fiducial marks are formed, including a pair of fiducial marks WM₁ and WM₂ corresponding to measurement marks RM₁₁ to RM₁₅ and RM₂₁ to RM₂₅ previously described and fiducial marks for baseline measurement of the alignment system, which will be described later in the description. As is shown in FIG. 3A, fiducial marks WM₁ and WM₂ are arranged on fiducial mark plate FM at an interval D in the X-axis direction. In this case, box-shaped marks are used as these fiducial marks WM₁ and WM₂. At least a part of the multiple fiducial marks may be formed directly on wafer stage WST (for example, on the wafer table).

Furthermore, as is disclosed in detail in, for example, Japanese Patent Application Laid-open No. H07-176468 and its corresponding U.S. Pat. No. 5,646,413, a pair of reticle alignment systems RA₁ and RA₂ (in FIG. 1, however, reticle alignment system RA₂ located in the depth of the page surface is omitted) based on an image processing method that have pick-up devices such as a CCD and use light of the exposure wavelength (in this embodiment, illumination light IL) as the alignment illumination light are arranged above reticle stage RST. In this case, the pair of reticle alignment systems RA, and RA₂ is arranged symmetrically (horizontally symmetrical) on the YZ plane, which includes optical axis AX of projection optical system PL. In addition, the pair of reticle alignment systems RA₁ and RA₂ is arranged reciprocally movable in the X-axis direction within the XZ plane that passes through optical axis AX. As long as the national laws in designated states or elected states, to which this international application is applied, permit, the disclosures of the above publication and U.S. patent are fully incorporated herein by reference.

Normally, the pair of reticle alignment systems RA₁ and RA₂ is set at a position where a pair of reticle alignment marks arranged outside the light shielding area of reticle R can be observed, respectively, in a state where reticle R is mounted on reticle stage RST. The pair of reticle alignment marks is arranged, in the X-axis direction at an interval 4D.

Furthermore, although it is omitted in the drawings, in exposure apparatus 100 in the embodiment, a multiple point focal position detection system based on an oblique incident method (hereinafter referred to as a ‘multiple point AF system’ as appropriate) is provided. The system has a light source whose on/off is controlled by main controller 20, and it detects the position of wafer W in the direction of optical axis AX (the Z-axis direction) and the inclination of wafer W with respect to the XY plane. Details on a multiple point AF system similar to the multiple point AF system in the embodiment are disclosed in, for example, Japanese Patent Application Laid-open No.H06-283403 and its corresponding U.S. Pat. No. 5,448,332.

On scanning exposure, which will be described later in the description, in addition to controlling the movement of wafer stage WST in the Z-axis direction via wafer stage drive section 28 based on focus signals FS from the multiple point AF system, main controller 20 also performs auto-focusing (automatic focusing) and auto-leveling to control the two-dimensional inclination (that is, rotation in the θx and θy directions), or more specifically, by controlling the movement of wafer stage WST using the multiple point AF system, the image forming plane of projection optical system PL and the surface of wafer W are made to substantially match within the irradiation area of illumination light IL (the area conjugate with illumination area IAR). As long as the national laws in designated states or elected states, to which this international application is applied, permit, the disclosures of the above publication and U.S. patent are fully incorporated herein by reference.

Furthermore, although it is omitted in the drawings, in exposure apparatus 100 in the embodiment, an off-axis alignment system is arranged on the side surface of projection optical system PL for detecting the alignment marks on wafer W and fiducial marks on fiducial mark plate FM. As the alignment system, for example, a sensor of an FIA system based on an image processing method is used. The sensor uses an image pickup device (such as a CCD) to pick up images of a subject mark on a photodetection surface formed by irradiating a broadband detection beam that does not expose the subject mark, and then outputs the pick-up signals. Besides the sensor of the FIA system, a sensor that detects scattered light or diffracted light generated from a subject mark when the subject mark is irradiated with a coherent detection beam, or a sensor that a light of two diffracted lights (such as in the same order) generated from the subject mark and made to interfere with each other can be used independently, or be appropriately combined.

Main controller 20 is made up of parts such as a workstation (or a microcomputer), and as is shown in FIG. 1, along with main controller 20, a storage unit 51 made up of a hard disk or the like, and an input/output device 30 made up of a keyboard, a pointing device such as a mouse, and a display such as a CRT or a liquid crystal panel are arranged. In storage unit 51, correlation information is stored that shows the relation between the position measurement errors of the reference point of movable mirrors 15y₁ and 15y₂ and the position of reticle stage RST in the non-scanning direction corresponding to such position measurement errors. The position measurement errors of the reference point of movable mirrors 15y₁ and 15y₂ are caused at least by the positional relation between the optical axes of the respective measurement beams Ma and Mb and the optical axes of the respective reference beams Ra and Rb individually corresponding to the optical axes of the measurement beams.

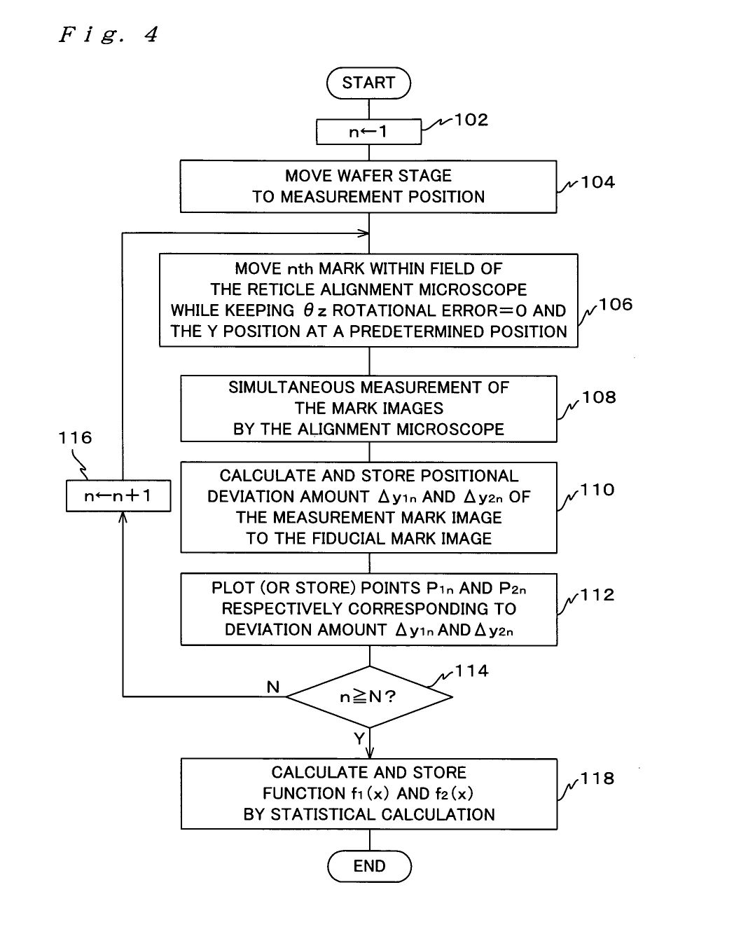

The method of making such correlation information will be described below, following the flow chart in FIG. 4 that shows the processing algorithm of main controller 20 (the internal CPU), appropriately referring to other drawings as well.

The flow chart in FIG. 4 (the corresponding processing algorithm) begins when an operator inputs instructions to start measurement via input/output device 30.

First of all, in step 102, main controller 20 initializes a counter n, which shows the mark number of the pair of measurement marks subject to measurement, to 1 (n←1).

In the next step, step 104, main controller 20 then controls wafer stage drive section 28 based on design values of the pair of fiducial marks WM₁ and WM₂ while monitoring the measurement values of wafer interferometer 31, and moves wafer stage WST to a measurement position. The measurement position, in this case, is a position where the mid point of the pair of fiducial marks WM₁ and WM₂ substantially coincides with the optical axis of projection optical system PL, and when the pair of reticle alignment systems RA₁ and RA₂ is at their normal position, fiducial marks WM₁ and WM₂ are positioned within the detection field of reticle alignment systems RA₁ and RA₂.

In the next step, step 106, main controller 20 moves reticle stage RST via reticle stage drive section 12 while monitoring the measurement values of the pair of reticle Y interferometers 13y₁ and 13y₂ so that while the θ rotational error of reticle stage RST is maintained at zero and the position of reticle stage RST is also maintained in the Y-axis direction (Y position), the n^{th} pair (in this case, the 1^{st}) of measurement marks RM₁ₙ and RM₂ₙ (in this case, RM₁₁ and RM₂₁) is located within the detection field of reticle alignment systems RA₁ and RA₂.

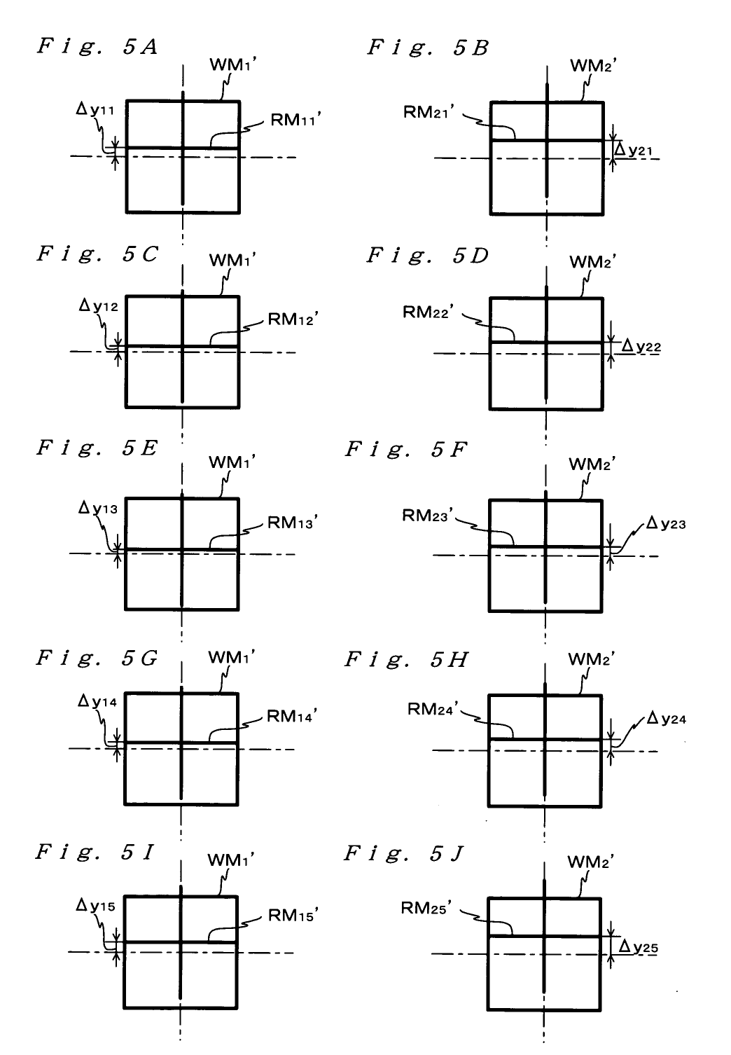

In the next step, step 108, main controller 20 simultaneously measures the images of the pair of measurement marks RM₁ₙ and RM₂ₙ (in this case, RM₁₁ and RM₂₁) and the corresponding fiducial marks WM₁ and WM₂, using the pair of reticle alignment systems RA₁ and RA₂. In this case, an image RM₁ₙ′ of measurement mark RM₁ₙ and an image WM₁′ of fiducial mark WM₁ are measured at the same time by reticle alignment system RA₁, and an image RM₂ₙ′ of measurement mark RM₂ₙ and an image WM₂′ of fiducial mark WM₂ are measured at the same time by reticle alignment system RA₂. In this case, as an example, reticle alignment system RA₁ measures an image RM₁₁′ of measurement mark RM₁₁ and an image WM₁′ of fiducial mark WM₁ that are shown in FIG. 5A, whereas, reticle alignment system RA₂ measures an image RM₂₁′ of measurement mark RM₂₁ and an image WM₂′ of fiducial mark WM₂ that are shown in FIG. 5B.

In the next step, step 110, based on the measurement results of step 108 described above, main controller 20 calculates a positional deviation amount Δy₁ₙ, which is the deviation amount of image RM₁ₙ′ of the measurement mark to image WM₁′ of the fiducial mark, and a positional deviation amount ΔY₂ₙ, which is the deviation amount of image RM₂ₙ′ of the measurement mark to image WM₂′ of the fiducial mark, and then stores the calculation results in memory such as the RAM. In this case, Δy₁₁ in FIG. 5A and ΔY₂₁ in FIG. 5B are calculated.

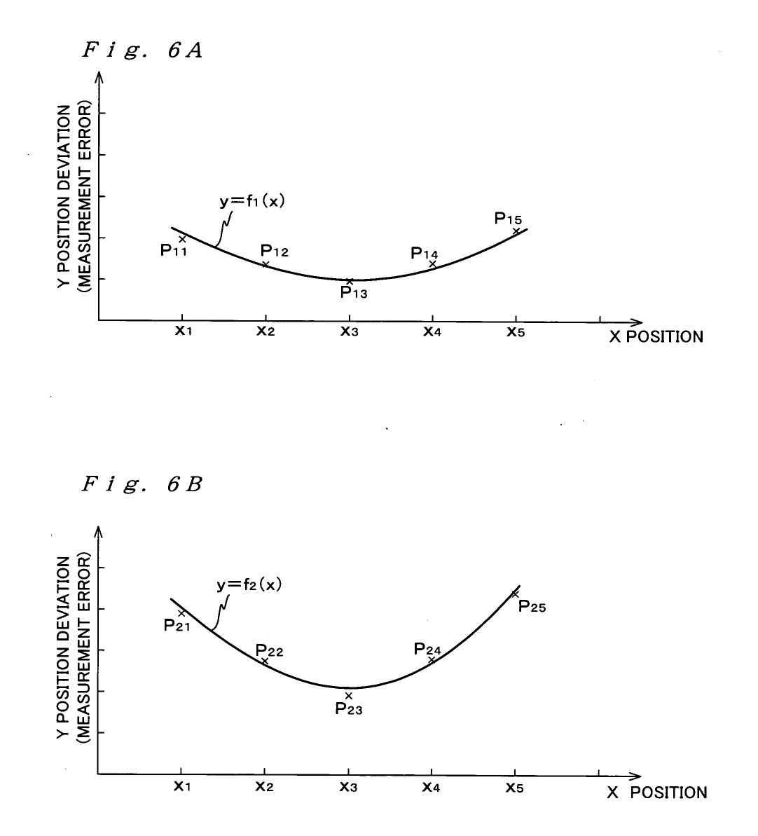

In the next step, step 112, main controller 20 plots a point P₁ₙ (Δy₁ₙ, xₙ) corresponding to positional deviation amount Δy₁ₙ and a point P₂ₙ (Δy₂ₙ, xₙ) corresponding to positional deviation amount Δy₂ₙ calculated in step 110 described above on a coordinate system whose lateral axis shows the position of reticle stage RST in the X-axis direction (the X position). In this case, point P₁₁ is plotted on a coordinate system shown in FIG. 6A, and point P₂₁ is plotted on a coordinate system shown in FIG. 6B.

In the next step, step 114, main controller 20 decides whether count value n of counter n is equal to or greater than N (in this case, N=5), which is half the total number of marks that is to be measured, or not. In the case the decision made is negative, then the step proceeds to step 116 where counter n is incremented by 1 (n←n+1). Then, the step returns to step 106 where the loop processing of steps 106→108→110→112→114→116 is repeatedly performed until the decision made in step 114 turns affirmative. With this operation, when n is from 2 to 5, the following processing is performed.

<when n=2>

In this case, in step 108, reticle alignment system RA₁ measures an image RM₁₂′ of measurement mark RM₁₂ and an image WM₁′ of fiducial mark WM₁ that are shown in FIG. 5C, whereas, reticle alignment system RA₂ measures an image RM₂₂′ of measurement mark RM₂₂ and an image WM₂′ of fiducial mark WM₂ that are shown in FIG. 5D. In addition, in step 110, Δy₁₂ in FIG. 5C and Δy₂₂ in FIG. 5D are calculated. Furthermore, in step 112, point P₁₂ is plotted on a coordinate system shown in FIG. 6A, and point P₂₂ is plotted on a coordinate system shown in FIG. 6B.

<when n=3>

In this case, in step 108, reticle alignment system RA, measures an image RM₁₃′ of measurement mark RM₁₃ and an image WM₁′ of fiducial mark WM₁ that are shown in FIG. 5E, whereas, reticle alignment system RA₂ measures an image RM₂₃′ of measurement mark RM₂₃ and an image WM₂′ of fiducial mark WM₂ that are shown in FIG. 5F. In addition, in step 110, Δy₁₃ in FIG. 5E and Δy₂₃ in FIG. 5F are calculated. Furthermore, in step 112, point P₁₃ is plotted on a coordinate system shown in FIG. 6A, and point P₂₃ is plotted on a coordinate system shown in FIG. 6B.

<when n=4>

In this case, in step 108, reticle alignment system RA, measures an image RM₁₄′ of measurement mark RM₁₄ and an image WM₁′ of fiducial mark WM₁ that are shown in FIG. 5G, whereas, reticle alignment system RA₂ measures an image RM₂₄′ of measurement mark RM₂₄ and an image WM₂′ of fiducial mark WM₂ that are shown in FIG. 5H. In addition, in step 110, Δy₁₄ in FIG. 5G and Δy₂₄ in FIG. 5H are calculated. Furthermore, in step 112, point P₁₄ is plotted on a coordinate system shown in FIG. 6A, and point P₂₄ is plotted on a coordinate system shown in FIG. 6B.

<when n=5>

In this case, in step 108, reticle alignment system RA, measures an image RM₁₅′ of measurement mark RM₁₅ and an image WM₁′ of fiducial mark WM₁ that are shown in FIG. 5I, whereas, reticle alignment system RA₂ measures an image RM₂₅′ of measurement mark RM₂₅ and an image WM₂′ of fiducial mark WM₂ that are shown in FIG. 5J. In addition, in step 110, Δy₁₅ in FIG. 5I and Δy₂₅ in FIG. 5J are calculated. Furthermore, in step 112, point P₁₅ is plotted on a coordinate system shown in FIG. 6A, and point P₂₅ is plotted on a coordinate system shown in FIG. 6B.

In this manner, when the processing in step 112 is completed when n=N=5, the decision made in step 114 turns affirmative, and the step then moves on to step 118. In step 118, approximation curves y=f₁(x) and y=f₂(x) are obtained, respectively, using discrete points P₁₁ to P₁₅ and P₂₁ to P₂₅, by statistical calculation such as the least squares calculation, and the information is stored in memory such as the RAM or within storage unit 51 as the correlation information previously described. The series of processing in the routine is thus completed. As a result, approximation curves y=f₁(x) shown in FIG. 6A and y=f₂(x) shown in FIG. 6B are stored. As the statistical calculation described above, instead of the least squares calculation, interpolation calculation may be used appropriately, such as the Spline method, in obtaining the functions by continuously interpolating the discrete data referred to above, and the functions may serve as the correlation information previously described.

The correlation information is not limited to the functions described above, and for example, in each case from n=1 to n=N, in step 112 described above, the coordinate values of points P₁ₙ and P₂ₙ may be sequentially stored within memory such as the RAM, and a table data (a correction map) may be made, which may also serve as the correlation information previously described.

The correlation information (functions y=f₁(x) and y=f₂(x) or the correction map) made in the manner described above is stored in storage unit 51 shown in FIG. 1

As is obvious from the making process of the correlation information described above, the correlation information (functions y=f₁(x) and y=f₂(x) or the correction map) is the information on the respective measurement errors of reticle Y interferometers 13y₁ and 13y₂ itself. The reason for this is because when the mark measurement described above is performed, positional deviation amounts in the Y-axis direction Δy₁ₙ and Δy₂ₙ of the pair of measurement marks RM₁n and RM₂ₙ to the corresponding fiducial marks WM₁ and WM₂ are measured at each stepping position with reticle stage RST being stepped in the X-axis direction at pitch p, while the Y-position of reticle stage RST is maintained at a predetermined value based on the measurement values of reticle Y interferometers 13y₁ and 13y₂, that is, the measurement is performed by relying on the measurement values. In this case, if there are no measurement errors in reticle Y interferometers 13y₁ and 13y₂, the center of measurement mark RM₁ₙ should coincide with the center of fiducial mark WM, and the center of measurement mark RM₂ₙ should also coincide with the center of fiducial mark WM₂, therefore, deviation amounts Δy₁ₙ and Δy₂ₙ should both be zero. In actual, however, because the reference point of the measurement beam of each reticle Y interferometer, or in the embodiment, the position of the tip of movable mirrors 15y₁ and 15y₂, deviates in the Y-axis direction by the measurement error amount, the positional attitude of reticle stage RST also changes from the ideal state (in this case, reticle stage RST will have a θz rotational error), and thus positional deviation amounts 13y₁ and 13y₂ are measured.

Next, operations in the exposure process of exposure apparatus 100 in the embodiment will be briefly described.

First of all, reticle R is carried by a reticle transfer system (not shown) and is held by suction on reticle stage RST at a loading position. Next, main controller 20 controls the position of wafer stage WST and reticle stage RST, and the pair of reticle alignment systems RA₁ and RA₂ performs relative position measurement of at least one pair of reticle alignment marks formed on reticle R and its corresponding reticle alignment fiducial marks on fiducial mark plate FM, and based on the results of the relative position measurement, the relation between a reticle stage coordinate system, which is set by the length measurement axis of reticle interferometer 13 and a wafer stage coordinate system, which is set by the length measurement axis of wafer interferometer 31, is calculated, that is, reticle alignment is performed.

Next, main controller 20 moves wafer stage WST so that fiducial mark plate FM is positioned directly under the off-axis alignment system, and then, measures the positional relation between the detection center of the alignment system and the baseline measurement fiducial marks on fiducial mark plate FM. Main controller 20 then obtains the relation between the baseline of the alignment system, that is, the projection position of the reticle pattern, and the detection center of the alignment system, based on the positional relation measured above, the positional relation between the pair of reticle alignment marks and its corresponding reticle alignment fiducial marks obtained during the reticle alignment described earlier, and the measurement values of wafer interferometer 31 obtained during the measurement of each positional relation. Details on operations such as reticle alignment and baseline measurement are disclosed in, for example, Japanese Patent Application Laid-open No.H07-176468 and its corresponding U.S. Pat. No. 5,646,413.

When the baseline measurement described above is completed, main controller 20 then performs wafer alignment by the EGA (Enhanced Global Alignment) method or the like whose details are disclosed in, for example, Japanese Patent Application Laid-open No. 61-44429 and its corresponding U.S. Pat. No. 4,780,617, and obtains the position of all the shot areas on wafer W. As long as the national laws in designated states or elected states, to which this international application is applied, permit, the disclosures of the above publication and U.S. patent are fully incorporated herein by reference.

Next, main controller 20 moves wafer stage WST to the scanning starting position (acceleration starting position) for exposure of the first shot area, based on the positional information of each shot area on wafer W obtained above and the baseline, while monitoring the positional information sent from interferometers 31 and 13. Main controller 20 also moves reticle stage RST to the scanning starting position, and then begins scanning exposure of the first shot area. In this case, on moving reticle stage RST to the scanning starting position, main controller 20 corrects the measurement values of reticle Y interferometers 13y₁ and 13y₂, based on the X positional information of reticle stage RST measured by reticle interferometer 13 (or to be more precise, reticle X interferometer 13x) and the correlation information (y=f₁(x), Y=f₂(x)) stored in storage unit 51. As a result, in the case the values of the measurement errors of reticle Y interferometers 13y₁ and 13y₂ (correction values) differ, the θz rotation of reticle stage RST will also be corrected.

Main controller 20 begins to relatively scan reticle stage RST and wafer stage WST in opposite directions along the Y-axis direction, and when both stages RST and WST each reach their target scanning speed, main controller 20 instructs illumination light IL to begin illuminating the pattern area of reticle R, and scanning exposure begins. In prior to the scanning exposure, the light source starts emission, however, because main controller 20 synchronously controls the movement of each blade of the movable blind making up the reticle blind and the movement of reticle stage RST, illumination light IL is kept from irradiating areas other than the pattern area on reticle R, as in a typical scanning stepper.

Main controller 20 synchronously controls reticle stage RST and wafer stage WST so that especially on scanning exposure described above, movement speed Vr of reticle stage RST in the Y-axis direction and movement speed Vw of wafer stage WST in the Y-axis direction are maintained at a speed ratio corresponding to projection magnification β of projection optical system PL. Even while such synchronous control of reticle stage RST and wafer stage WST is being performed, main controller 20 corrects the measurement values of reticle Y interferometers 13y₁ and 13y₂, based on the X positional information of reticle stage RST measured by reticle interferometer 13 (or to be more precise, reticle X interferometer 13x) and the correlation information (y=f₁(x), Y=f₂(x)) stored in storage unit 51, in the same manner as the description above.

Then, different areas in the pattern area of reticle R are sequentially illuminated with an ultraviolet pulsed light, and scanning exposure of the first shot area on wafer W ends when the entire surface of the pattern area has been completely illuminated. By this operation, the circuit pattern on reticle R is reduced and transferred onto the first shot area via projection optical system PL. And, during the scanning exposure, main controller 20 performs auto focusing and auto leveling, which are previously described, using the multiple point AF system.

And then, when scanning exposure of the first shot area ends in the manner described above, main controller 20 performs a stepping operation in between shots to move wafer stage WST to the scanning starting position (acceleration starting position) of the second shot area. Then, main controller 20 performs scanning exposure of the second shot area in the same manner as in the first shot area described above. Hereinafter, the same operations are performed for the third shot area and the rest of the shot areas.

In this manner, the stepping operation in between shots and the scanning exposure operation of the shot areas are repeatedly performed, and the pattern of reticle R is transferred onto all the shot areas on wafer W by a step-and-scan method.

In exposure apparatus 100 in the embodiment, the making process of the correlation information (the processing from step 102 to step 118 in FIG. 4) may be repeatedly performed, for example, at a predetermined timing by instructions from the operator, and the correlation information stored in the storage unit may be updated each time the process is performed using f₁(x) and f₂(x) calculated in step 118. This allows main controller 20 to perform position control of reticle stage RST with good precision at all times, without being affected when the measurement error of reticle Y interferometer changes over time for some reason.

As is obvious from the description so far, in the embodiment, reticle stage drive section 12 and wafer stage drive section 28 make up a drive system that drives reticle stage RST and wafer stage WST in the scanning direction. And, main controller 20 makes up a control system.

As is described so far, according to exposure apparatus 100 in the embodiment, on measuring the position of reticle stage RST, main controller 20 measures the positional relation of reticle stage RST in the Y-axis direction (a first axis direction) based on the output of reticle Y interferometers 13y₁ and 13y₂, which receives the reflecting beams of measurement beams Ma and Mb irradiated on the pair of Y-axis movable mirrors 15y₁ and 15y₂ on reticle stage RST, as well as measure the positional relation of reticle stage RST in the X-axis direction (a second axis direction) using reticle X interferometers 13x, which serves as a second axis direction position measuring unit. Then, main controller 20 calculates the positional information on the Y-axis direction of reticle stage RST and the θz direction whose measurement errors of reticle Y interferometers 13y₁ and 13y₂ have been corrected. This calculation is based on the information stored in storage unit 51, on the positional relation between the optical axis of measurement beams Ma and Mb of reticle Y interferometers 13y₁ and 13y₂ and the optical axis of reference beams Ra and Rb, on the correlation information (functions y=f₁(x), Y=f₂(x), and the like) that shows the relation between the position measurement errors of the reference point (the tip position described earlier) on the reflection surface of Y-axis movable mirrors 15y₁ and 15y₂ caused by the wavefront aberration of beams Ma and Mb and also beams Ra and Rb and the position of reticle stage RST in the X-axis direction corresponding to such position measurement errors, and on the positional information on the X-axis direction of reticle stage RST that has been measured. This allows main controller 20 to obtain positional information whose position measurement errors of reticle stage RST in the Y-axis direction and the θz direction, which are caused by the reciprocal actions of a walk off due to the optical axis deviation of reticle Y interferometers 13y₁ and 13y₂ and the wavefront aberration of the beams, have been corrected according to the position of reticle stage RST in the X-axis direction. Accordingly, positional information on the Y-axis direction and θz direction of reticle stage RST can be measured with good precision, using a light wave interference length-measuring instrument such as reticle Y interferometers 13y₁ and 13y₂.

In addition, in exposure apparatus 100 in the embodiment, main controller 20 obtains the correlation information by actual measurement, by performing the processing according to the flow chart in FIG. 4, and the information is stored in storage unit 51. Therefore, by controlling the position of reticle stage RST in the manner described above using the correlation information stored in storage unit 51, main controller 20 can perform position control with high precision, based on the positional information whose influence of manufacturing errors, adjustment errors (including attachment errors) of each parts of the measuring system including reticle Y interferometers 13y₁ and 13y₂, movable mirrors, and fixed mirrors have been corrected all at once.

In addition, with exposure apparatus 100 in the embodiment, with the position measuring method described above, the positional information on the Y-axis direction (and the θz direction) of reticle stage RST can be measured with good accuracy using reticle Y interferometers 13y₁ and 13y₂. And, because main controller 20 controls the position of reticle stage RST in the Y-axis direction (the first axis direction) based on such positional information measured with good accuracy, the position of reticle stage RST in the Y-axis direction (the scanning direction) can be controlled with high precision.

Furthermore, with exposure apparatus 100 in the embodiment, when scanning exposure is performed, main controller 20 measures the positional information on the Y-axis direction (the scanning direction) and the X-axis direction (the non-scanning direction) of reticle stage RST where reticle R is mounted, based on the measurement results of reticle Y interferometers 13y₁ and 13y₂ and reticle X interferometer 13x, as well as measure the positional information of wafer stage WST where wafer W is mounted in at least the direction of five degrees of freedom including the Y-axis, the X-axis, and the θz directions based on the measurement results of wafer interferometer 31. Then, as for reticle stage RST, main controller 20 obtains the positional information of the first stage in the Y-axis direction (and the θz direction) whose measurement errors by reticle Y interferometers 13y₁ and 13y₂ have been corrected, based on the measurement results of the positional information on the X-axis direction and the correlation information described earlier stored in storage unit 51. And then, based on the corrected positional information on the Y-axis direction (and the θz direction) of reticle stage RST, and the positional information of wafer stage WST in at least the directions of five degrees of freedom, including the Y-axis, the X-axis, and the θz directions, main controller 20 controls reticle stage RST and wafer stage WST.

Accordingly, main controller 20 performs synchronous control of reticle stage RST and wafer stage WST, that is, main controller 20 synchronously controls reticle R and wafer W with good precision, which makes it possible to improve the synchronous precision as well as reduce the synchronization settling time, and by the exposure with high precision by the scanning exposure method, the pattern of reticle R can be transferred with good precision on each of the shot areas on wafer W.

In the embodiment above, because the pair of Y interferometers 13y₁ and 13y₂ are used for measuring the position of reticle stage RST in the Y-axis direction, as a matter of course, the positional information on the θz direction is also obtained with good precision, in addition to that of the Y-axis direction. The present invention, however, is not limited to this, and in the case only one interferometer is to be used for measuring the position of reticle stage RST in the Y-axis direction, only the positional information on the Y-axis direction of reticle stage RST is obtained with good precision in a similar manner as in the description above. In addition, in the case at least one of the Y interferometers 13y₁ and 13y₂ used for measuring the position of reticle stage RST in the Y-axis direction is made up of a dual-axis interferometer that has two length measuring axes, and the arrangement is employed where the measurement beams of each length measuring axis are incident on different Z positions on the corresponding movable mirrors, the positional information on the θx direction (the pitching direction), which is the rotational direction around the X-axis can be measured with good precision, in addition to the Y-axis direction and the θz direction.

In addition, in the embodiment above, by measuring the positional deviation amount of measurement marks on reticle stage RST and the fiducial marks on fiducial mark plate FM, the position measurement errors of the tip of movable mirrors 15y₁ and 15y₂ (the reference point on the reflection surface) are obtained. The present invention, however, is not limited to this, and any measuring method or calculation method may be employed, as long as reticle stage RST is stepped to a plurality of positions in the X-axis direction using the measurement values of reticle X interferometer 13x and the positional errors of the tip of movable mirrors 15y₁ and 15y₂ (the reference point on the reflection surface) are obtained at each stepped position, while maintaining the position of reticle stage RST at a predetermined coordinate position in the Y-axis direction based on the measurement values of reticle Y interferometers 13y₁ and 13y₂. For example, the wavefront aberration of the measurement beams and the reference beams that are previously described may be measured in advance, and the deviation amount of the beams maybe calculated (estimated) from the relation described earlier referring to FIGS. 10A and 10B according to the X position, and then by calculation based on the estimated results and the wavefront aberration, the measurement error δL (=ΔL1−ΔL2) described earlier may be obtained (refer to FIGS. 10A and 10B). As is described, whatever the method is, it does not matter as long as the correlation information is made similarly as in the description above, based on the position measurement errors obtained at each stepped position.

In the embodiment above, in the case table data (correction map) is made instead of function data (y=f₁(x), y=f₂(x)) as the correlation information, on actually measuring the position of reticle stage RST, main controller 20 may use the calculation results of interpolating the position measurement errors (the discrete data) for each stepped position in the correction map according to the positional information on the X-axis direction of reticle stage RST measured by a predetermined interpolation calculation in order to calculate the measurement errors of reticle Y interferometers 13y₁ and 13y₂ at the X positions. In this case, main controller 20 may calculate the positional information whose calculated measurement errors have been corrected.

Furthermore, in the embodiment above, main controller 20 corrects the measurement values of reticle Y interferometers 13y₁ and 13y₂ (that is, the position in the scanning direction and the rotational amount in the θz direction) based on the correlation information, and controls the position of reticle stage RST in the scanning direction and its rotation based on the correction values. The present invention, however, is not limited to this, and in order to correct the relative positional errors of reticle R and wafer W that occur due to the measurement errors by reticle Y interferometers 13y₁ and 13y₂ of at least either the position in the scanning direction or the rotational amount in the θz direction, instead of reticle stage RST, or combined with reticle stage RST, main controller 20 may control the position of wafer stage WST in the scanning direction and its rotation, using the correlation information and the positional information on the non-scanning direction of reticle stage RST. In addition, main controller 20 may calculate only the measurement errors described above using the correlation information and the positional information on the non-scanning direction of reticle stage RST, without correcting the measurement values of reticle Y interferometers 13y₁ and 13y₂. In this case, main controller 20 only has to control at least either the position or rotation of at least either reticle stage RST or wafer stage WST based on the calculated measurement errors so that the relative positional error of reticle R and wafer W caused by the calculated measurement errors is substantially zero. Furthermore, main controller 20 may correct the target positional information on the scanning direction (the Y-axis direction) of at least either reticle stage RST or wafer stage WST based on the correlation information and the positional information on the non-scanning direction of reticle stage RST, and then may control the movement of that one stage so that the measurement values of the stage by the Y interferometer substantially coincides with the corrected target positional information.

In addition, in the embodiment above, when the correlation information or the table data is made, reticle stage RST is made to step in the X-axis direction so that the pair of reticle alignment systems RA₁ and RA₂ each measures n measurement marks, RM₁ₙ and RM₂ₙ. However, on detecting the measurement marks RM₁ₙ and RM₂ₙ, reticle stage RST does not have to be positioned (stopped) and it may be moved continuously.

Furthermore, in the embodiment above, on detecting the measurement marks RM₁ₙ and RM₂ₙ with reticle alignment systems RA₁ and RA₂, reticle stage RST is moved while maintaining its position in the Y-axis direction at a predetermined coordinate position, however, the position in the Y-axis direction does not have to be maintained at a predetermined coordinate position while reticle stage RST is being moved. In this case, for example, by correcting the detection results of reticle alignment systems RA₁ and RA₂ (the positional deviation amount Δy₁ₙ and Δy₂ₙ described earlier) based on the measurement values of reticle Y interferometers 13y₁ and 13y₂, which are obtained on detecting the measurement marks RM₁ₙ and RM₂ₙ by reticle alignment systems RA₁ and RA₂, the influence of the positional change of reticle stage RST in the Y-axis direction and the rotational amount (the yawing amount) can be excluded, and the corrected values can be used to calculate the correlation information or the table data.

In addition, in the embodiment above, when making the correlation information or the table data, attachment errors and manufacturing errors (that is, errors related to the position where measurement marks RM₁ₙ and RM₂ₙ and fiducial marks WM₁ and WM₂ are formed) of reticle fiducial plate RFM and fiducial mark plate FM are not taken into account, however, at least one of these errors may be used to calculate the correlation information. When such errors change over time due to factors such as vibration or heat, the update of the error information by calculation, simulation, or the like, or actual measurement may be performed periodically, and based on such results, the correlation information can be calculated, that is, the position of at least either reticle stage RST or wafer stage WST may be controlled.

In the embodiment above, the case has been described where movable mirrors 15y₁ and 15y₂ on which the measurement beams from reticle Y interferometers 13y₁ and 13y₂ are irradiated are made of hollow retroreflectors. This takes into consideration the point that measurement errors can be corrected even if hollow retroreflectors have relatively large measurement errors that occur due to the reciprocal action of wavefront aberration and walk off, and the point that measurement errors by the influence of yawing hardly occurs. The present invention, however, is not limited to this, and prisms or other reflection surfaces may also be used.

In addition, as reference mirrors 14y₁ and 14y₂, as a matter of course, prisms other than the hollow retroreflector, a retroreflector that is solid (also called a corner cube prism) may also be used, as well as a flat mirror. Furthermore, the position measuring unit for measuring the position of reticle stage RST in the non-scanning direction is not limited to laser interferometers, and encoders or other position measuring units may also be used.

In the case the laser interferometer is used as the position measuring unit for measuring the position of reticle stage RST in the non-scanning direction, reticle X interferometer may be a multi-axis interferometer that has a plurality of measurement axes so that in addition to measuring the positional information on the non-scanning direction (the X-axis direction) of reticle stage RST, the rotational amount in at least either the θy direction or in the θz direction can be measured.

In addition, in the embodiment above, the case has been described where the errors are measured using reticle fiducial plate RFM on which the measurement marks are formed. The present invention, however, is not limited to this, and a measurement reticle used only for measurement purposes or a reticle that has measurement marks formed used for manufacturing devices may be used. In addition, in any case, manufacturing errors are preferably measured in advance, and the measurement errors corrected at times such as when measuring or controlling the position of the reticle stage, or when making the correlation information. Furthermore, the shape of the measurement marks formed on reticle fiducial plate RFM or on the measurement reticle is not limited to the + mark, and the shape can be optional.

In addition, in the embodiment above, the reticle alignment system by an imaging method is used when obtaining the correlation information. The reticle alignment system, however, is not limited to the imaging method, and the method of detecting scattered light or diffracted light from the measurement marks or the fiducial marks may be employed, or some other optical sensor may be used as the reticle alignment system. For example, the method may be employed where the detection is performed by irradiating a coherent beam on either a measurement mark arranged on the object side of the projection optical system or on a fiducial mark arranged on the image plane side, and then when the mark generates a diffracted light, it is irradiated on the other mark via the projection optical system, and the diffracted lights of the same order generated by the other mark are made to interfere with one another.

In addition, in the embodiment above, the case has been described where a single-pass heterodyne interferometer is used as reticle Y interferometers 13y₁ and 13y₂, however, it is a matter of course that the present invention is not limited to this. That is, as reticle Y interferometers 13y₁ and 13y₂, the so-called double pass interferometer may also be used, and also in this case, main controller 20 can measure and control the position of reticle stage RST that has been corrected with good precision in a similar manner as the procedure previously described. In addition, the present invention can be suitably applied not only when the heterodyne interferometer is used, but also when an interferometer by a different method or even when other light wave interference length-measuring instruments are used.

Furthermore, in the embodiment above the pair of Y-axis movable mirrors 15y₁ and 15y₂ is fixed on the upper surface of reticle stage RST. The arrangement, however, is not limited to this, and for example, it may be fixed to the side surface of reticle stage RST, or the end section of reticle stage RST (reticle fine movement stage) may be processed as a movable mirror. The length measurement beam (measurement beam) of the reticle Y interferometer in the optical axis direction (the Z-axis direction) of projection optical system PL is preferably made to match the pattern surface of reticle R, and in this state, as long as the Y-axis movable mirrors can reflect the measurement beams, they may be arranged in any way. In addition, the Y-axis movable mirrors arranged (two in this case, 15y₁ and 15y₂) may be only one, three, or more. Furthermore, in the embodiment above, reference mirrors 14x, 14y₁, and 14y₂ of reticle interferometer 13 are fixed to the barrel of projection optical system PL. The arrangement, however, is not limited to this, and is optional. In addition, in the embodiment above, the movable mirrors are provided on reticle fine movement stage, however, adding to these mirrors, a Y-axis interferometer may also be disposed on reticle rough movement stage and a movable mirror (a retroreflector) corresponding to the interferometer may be provided on the end section of reticle rough movement stage. And, in this case as well, the present invention can be suitably applied. Furthermore, reticle stage RST is not limited to the rough/fine movement stage, and it may employ any arrangement.

In the embodiment above, the case has been described where the present invention is applied to a projection exposure apparatus based on a step-and-scan method. The present invention, however, is not limited to this, and as long as the exposure apparatus comprises at least one stage unit that has relatively large movement strokes in an axial direction, the present invention can be suitably applied. For example, in the case of a scanning exposure apparatus of equal magnification whose mask stage and substrate stage synchronously move in an axial direction with respect to the projection optical system (used as a liquid crystal exposure apparatus), the position measuring method and the position control method of the present invention can be suitably applied to the substrate stage instead of the mask stage, or along with the mask stage. Furthermore, the position measuring method and the position control method of the present invention is not limited to stages in the exposure apparatus, and it can be suitably applied to a moving body as long as it has a reflection surface, has predetermined strokes in at least one axial direction, and can move in the direction orthogonal to the axial direction.

In addition, in the embodiment above, the case has been described where the present invention is applied to an exposure apparatus used for manufacturing semiconductor devices. The present invention, however, is not limited to this, and the present invention can also be applied to an exposure apparatus for manufacturing liquid crystal displays that transfers a liquid crystal display deice pattern onto a square shaped glass plate, an exposure apparatus used for manufacturing display devices, such as a plasma display or an organic EL, and thin-film magnetic heads that transfers a device pattern onto a ceramic wafer, an exposure apparatus used for manufacturing imaging devices (such as a CCD), micromachines, DNA chips, and the like. In addition, the present invention can also be suitably applied to an exposure apparatus that transfers a circuit pattern onto a glass substrate or a silicon wafer not only when producing microdevices such as semiconductors, but also when producing a reticle or a mask used in exposure apparatus such as an optical exposure apparatus, an EUV exposure apparatus, an X-ray exposure apparatus, or an electron beam exposure apparatus. In the exposure apparatus that uses DUV (deep (far) ultraviolet) light or VUV (vacuum ultraviolet) light, a transmittance type reticle is normally used, and as the reticle substrate, materials such as silica glass, fluorine-doped silica glass, fluorite, magnesium fluoride, or crystal are used. Furthermore, in a proximity X-ray exposure apparatus, an electron beam exposure apparatus, or the like, a transmittance type mask (stencil mask, membrane mask) is used, and as the mask substrate, a silicon wafer or the like is used.

In addition, in the embodiment above, as the light source, an ultraviolet light source such as the KrF excimer laser light source, or a pulsed laser light source of the vacuum ultraviolet region such as the F₂ laser or the ArF excimer laser is used. The present invention, however, is not limited to this, and other vacuum ultraviolet light sources such as the Ar₂ laser light source (output wavelength: 126 nm) may also be used. In addition, for example, the ultraviolet light is not limited only to the laser beams emitted from each of the light sources referred to above, and a harmonic wave may also be used that is obtained by amplifying a single-wavelength laser beam in the infrared or visible range emitted by a DFB semiconductor laser or fiber laser, with a fiber amplifier doped with, for example, erbium (Er) (or both erbium and ytteribium (Yb)), and by converting the wavelength into ultraviolet light using a nonlinear optical crystal. Furthermore, the present invention can be applied to an exposure apparatus that uses, for example, EUV light or the X-ray, or charged particle beams such as electron beam or an ion beam. Besides the description above, the present invention may also be applied to an immersion exposure apparatus that has liquid filled in between projection optical system PL and the wafer whose details are disclosed in, for example, the pamphlet of International Publication Number WO99/49504 or the like. In addition, the present invention may also be applied to an exposure apparatus that has two wafer stages that can each move independently. Details on such an exposure apparatus by the twin wafer stage method are disclosed in, for example, Japanese Patent Application Laid-open No.H10-214783 and its corresponding U.S. Pat. No. 6,341,007, as well as in the pamphlet of International Publication Number WO98/40791 and its corresponding U.S. Pat. No. 6,262,796. As long as the national laws in designated states or elected states, to which this international application is applied, permit, the disclosures of the U.S. patents cited above are fully incorporated herein by reference.

In addition, in the embodiment above, the case has been described where a system that is both a reduction system and a refraction system is used as the projection optical system. The present invention, however, is not limited to this, and a system of equal magnification or a magnifying system may also be used as the system, as well as a refraction system, a dioptric system, or a reflection system. In addition, in the case a reduction system similar to the embodiment above is used, projection magnification β may be ⅕, ⅙, or the like, and in such a case, details such as the size and arrangement of the measurement marks and fiducial marks are preferably decided according to the magnification.

Exposure apparatus 100 in the embodiment above can be made by incorporating the illumination optical system made up of a plurality of lenses and projection optical system PL into the exposure apparatus main body and performing optical adjustment, as well as assembling reticle stage RST and wafer stage WST built from many mechanical parts into the exposure apparatus main body and connecting the wiring and piping, and then performing total adjustment (such as electric adjustment and operation adjustment). The making of the exposure apparatus is preferably performed in a clean room where the temperature, degree of cleanliness, and the like are controlled.

Device Manufacturing Method

Next, an embodiment of a device manufacturing method that uses the exposure apparatus described above in a lithographic process is described.

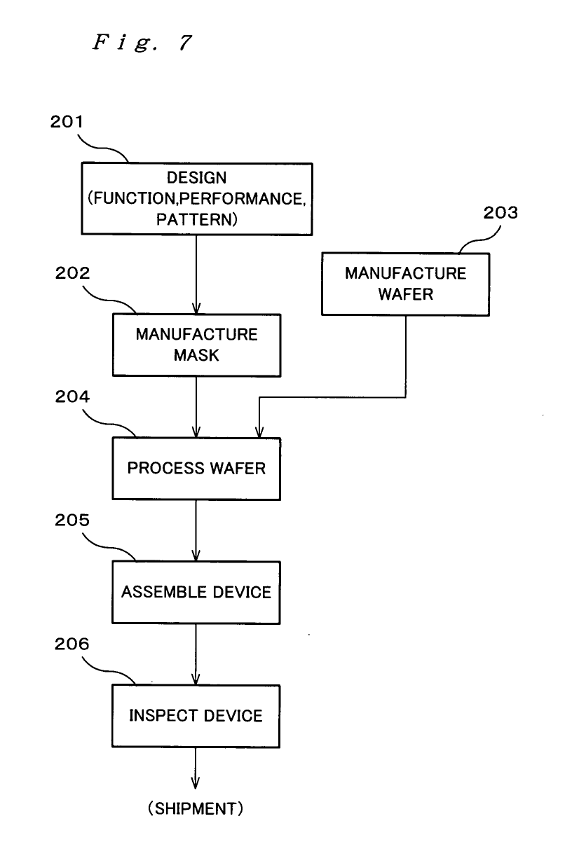

FIG. 7 is a flow chart showing an example of manufacturing a device (a semiconductor chip such as an IC or an LSI, a liquid crystal panel, a CCD, a thin magnetic head, a micromachine, or the like). As shown in FIG. 7, in step 201 (design step), function/performance is designed for a device (for example, circuit design for a semiconductor device) and a pattern to implement the function is designed. In step 202 (mask manufacturing step), a mask on which the designed circuit pattern is formed is manufactured, whereas, in step 203 (wafer manufacturing step), a wafer is manufacturing by using a silicon material or the like.

In step 204 (wafer processing step), an actual circuit and the like is formed on the wafer by lithography or the like using the mask and wafer prepared in steps 201 to 203, as will be described later. Next, in step 205 (device assembly step) a device is assembled using the wafer processed in step 204. The step 205 includes processes such as dicing, bonding, and packaging (chip encapsulation), as necessary.

Finally, in step 206 (inspection step), tests on operation, durability, and the like are performed on the device processed in step 205. After these steps, the device is completed and shipped out.

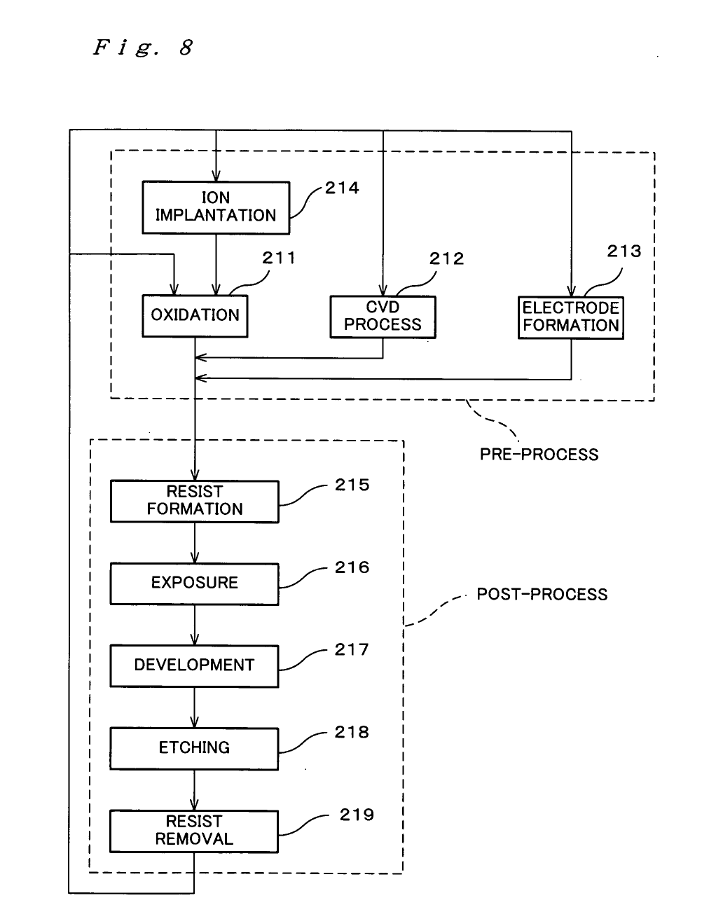

FIG. 8 is a flow chart showing a detailed example of step 204 described above in manufacturing the semiconductor device. Referring to FIG. 8, in step 211 (oxidation step), the surface of the wafer is oxidized. Instep 212 (CVD step), an insulating film is formed on the wafer surface. In step 213 (electrode formation step), an electrode is formed on the wafer by vapor deposition. In step 214 (ion implantation step), ions are implanted into the wafer. Steps 211 to 214 described above make up a pre-process for the respective steps in the wafer process, and are selectively executed depending on the processing required in the respective steps.

When the above pre-process is completed in the respective steps in the wafer processing, a post-process is executed in the following manner. In this post-process, first, in step 215 (resist formation step), the wafer is coated with a photosensitive agent. Next, in step 216 (exposure step), the circuit pattern on the mask is transferred onto the wafer by the exposure apparatus and the exposure method described above. And, in step 217 (development step), the wafer that has been exposed is developed. Then, in step 218 (etching step), an exposed member of an area other than the area where the resist remains is removed by etching. Finally, in step 219 (resist removing step), when etching is completed, the resist that is no longer necessary is removed.

By repeatedly performing these pre-process and post-process steps, multiple circuit patterns are formed on the wafer.

By using such device manufacturing method described above in the embodiment, since the exposure apparatus and the exposure method described in the embodiment above are used in the exposure process, the reticle pattern can be transferred onto the wafer with good precision. As a consequence, the productivity (including yield) of highly integrated devices can be improved.

While the above-described embodiment of the present invention is the presently preferred embodiment thereof, those skilled in the art of lithography systems will readily recognize that numerous additions, modifications, and substitutions may be made to the above-described embodiment without departing from the spirit and scope thereof. It is intended that all such modifications, additions, and substitutions fall within the scope of the present invention, which is best defined by the claims appended below.

1. A position measuring method of measuring positional information on at least an axial direction of a moving body that has a reflection surface using a light wave interference length-measuring instrument, said method comprising:
a process in which positional information on a first axis direction of said moving body is measured, based on an output of said light wave interference length-measuring instrument that receives reflection beams of measurement beams irradiated on said reflection surface, and positional information on a second axis direction orthogonal to said first axis of said moving body is measured using a second axis direction position measuring unit; and
a process in which measurement errors in said positional information on said first axis direction of said moving body by said light wave interference length-measuring instrument are calculated, based on correlation information, which denotes a relation between position measurement errors of a reference point on said reflection surface and the position related to said second axis direction of said moving body corresponding to said position measurement errors, said errors being caused at least by a positional relation between an optical axis of measurement beams and an optical axis of reference beams of said light wave interference length-measuring instrument, and on positional information on said second axis direction of said moving body that has been measured.

2. The position measuring method of claim 1, said method further comprising:
a process performed prior to said process of measuring positional information, in which while the position of said moving body in said first axis direction is detected based on said output of said light wave interference length-measuring instrument that receives reflection beams of measurement beams irradiated on said reflection surface, said moving body is moved in said second axis direction using said second axis direction position measuring unit, position measurement errors of said reference point on said reflection surface are obtained at each of a plurality of positions in said second axis direction, and said correlation information is made based on said position measurement errors obtained at each of said plurality of positions.

3. The position measuring method of claim 2, wherein
in said position measuring method, said position measurement errors of said reference point on said reflection surface are calculated by a predetermined calculation, based on a deviation amount of a measurement optical axis of said light wave interference length-measuring instrument to a reference optical axis and said positional information on said second axis direction of said moving body.

4. The position measuring method of claim 2, wherein
said position measurement errors of said reference point on said reflection surface are obtained, based on measurement results of measuring a positional relation between measurement marks provided in a part of said moving body and fiducial marks provided on a fiducial object.

5. The position measuring method of claim 2, wherein
said correlation information is function data calculated based on each plot point data, which are said position measurement errors of said reference point on said reflection surface obtained at each of said positions in said second axis direction, plotted on a predetermined coordinate system.

6. The position measuring method of claim 2, wherein
said correlation information is a table data made using said position measurement errors of said reference point on said reflection surface obtained at each of said positions in said second axis direction.

7. The position measuring method of claim 2, wherein
in said process of calculating measurement errors, said errors are calculated using calculation results that are interpolated by a predetermined interpolation calculation of said position measurement errors at each of said plurality of positions in said second axis direction in said correlation information, according to said positional information on said second axis direction of said moving body that has been measured.

8. The position measuring method of claim 2, wherein
in said process of making said correlation information, said moving body is moved in said second axis direction while substantially maintaining the position of said moving body in said first axis direction at a predetermined coordinate position based on said output of said light wave interference length-measuring instrument.

9. The position measuring method of claim 1, wherein
in said process of calculating measurement errors, said measurement errors are calculated with further consideration of attitude of said moving body.

10. The position measuring method of claim 1, wherein
said position measurement errors included in said correlation information are further caused by wavefront aberration generated in said measurement beams.

11. The position measuring method of claim 1, wherein
said reflection surface is a reflection surface of a hollow retroreflector fixed to said moving body.

12. The position measuring method of claim 1, said method further comprising:
a process in which positional information on said first axis direction of said moving body whose said measurement error have been corrected is calculated.

13. A position control method of controlling the position of a moving body whose position is measured in at least an axial direction using a light wave interference length-measuring instrument, said method comprising:
a position measuring process in which the position measuring method of claim 1 is performed to measure positional information on said first axis direction of said moving body; and
a process in which position of said moving body in at least said first axis direction is controlled, taking into consideration information obtained in said position measuring process.

14. An exposure method of transferring a pattern formed on a mask onto a photosensitive object by synchronously moving said mask and said photosensitive object in a predetermined direction, wherein
positional information on said predetermined direction of at least one of a first moving body on which said mask is mounted and a second moving body on which said photosensitive object is mounted is measured, using the position measuring method of claim 1, and transfer of said pattern onto said photosensitive object is performed by controlling position of at least one of said first moving body and said second moving body in said predetermined direction, taking into consideration information obtained by results of said measurement.

15. A device manufacturing method including a lithographic process, wherein
in said lithographic process, a pattern of a microdevice is transferred onto a photosensitive object using the exposure method in claim 14.

16. An exposure apparatus that synchronously moves a mask and photosensitive object in a predetermined scanning direction and transfers a pattern formed on said mask onto said photosensitive object, said apparatus comprising:
a first stage on which said mask is mounted and a reflection surface provided;
a second stage on which said photosensitive object is mounted;
a drive system that drives said first stage and said second stage;
a first measuring system that has a light wave interference length-measuring instrument, which irradiates a measurement beam on said reflection surface and measures positional information on said scanning direction of said first stage, and a measuring unit, which measures positional information on a non-scanning direction orthogonal to said scanning direction of said first stage;
a second measuring system that measures positional information on at least said scanning direction of said second stage;
a control unit that controls said drive system, based on measurement results of said first measuring system and said second measuring system, and on correlation information, which denotes a relation between position measurement errors of a reference point on said reflection surface and the position related to said non-scanning direction of said first stage corresponding to said position measurement errors, said errors being caused at least by a positional relation between an optical axis of measurement beams and an optical axis of reference beams of said light wave interference length-measuring instrument.

17. The exposure apparatus of claim 16, wherein
said control unit corrects relative positional errors of said mask and said photosensitive object in said scanning direction caused by measurement errors of said first stage by said light wave interference length-measuring instrument, using said correlation information and said positional information on said non-scanning direction of said first stage.

18. The exposure apparatus of claim 16, wherein
said control unit calculates information on measurement errors of said first stage by said light wave interference length-measuring instrument, based on said correlation information and said positional information on said non-scanning direction of said first stage, and uses said calculated information when moving said first stage in said scanning direction.

19. The exposure apparatus of claim 16, wherein
said control unit calculates positional information on said scanning direction of said first stage whose measurement errors by said light wave interference length-measuring instrument have been corrected, based on said correlation information and said positional information on said non-scanning direction of said first stage, and uses said calculated information when moving said first stage in said scanning direction.

20. The exposure apparatus of claim 16, wherein
said correlation information is made in advance, based on said position measurement errors of a reference point on said reflection surface obtained at each of a plurality of positions in said non-scanning direction by said control unit, which moves said first stage in said non-scanning direction via said drive system while detecting the position of said first stage in said scanning direction based on an output of said light wave interference length-measuring instrument.

21. The exposure apparatus of claim 20, wherein
said control unit controls said first stage via said drive system when making said correlation information, and also has a storage unit that stores said correlation information that has been made.

22. The exposure apparatus of claim 20, said apparatus further comprising:
a mark measuring system that measures a positional relation between measurement marks provided on a part of said first stage and fiducial marks provided on a reference object, wherein
said position measurement errors of a reference point on said reflection surface is obtained based on measurement results of said mark measuring system.

23. The exposure apparatus of claim 20, wherein
said correlation information is a table data made using said position measurement errors of said reference point on said reflection surface obtained at each of said positions in said non-scanning direction.

24. The exposure apparatus of claim 23, wherein
said measurement errors by said light wave interference length-measuring instrument are calculated using calculation results that are interpolated by a predetermined interpolation calculation of said position measurement errors at each of said plurality of positions in said non-scanning direction in said correlation information, according to positional information on said non-scanning direction that has been measured of said first stage.

25. The exposure apparatus of claim 20, wherein
said correlation information is function data calculated based each plot point data, which are said position measurement errors of said reference point on said reflection surface obtained at each of said positions in said non-scanning direction, plotted on a predetermined coordinate system.

26. The exposure apparatus of claim 20, wherein
when making said correlation information, said control unit moves said first stage in said non-scanning direction, while substantially maintaining the position of said first stage in said scanning direction at a predetermined position based on said output of said light wave interference length-measuring instrument.

27. The exposure apparatus of claim 16, wherein
said control unit calculates said position measurement errors with further consideration of attitude of said first stage.

28. The exposure apparatus of claim 16, wherein
said position measurement errors included in said correlation information are further caused by wavefront aberration generated in said measurement beams.

29. The exposure apparatus of claim 16, wherein
said reflection surface is a reflection surface of a hollow retroreflector.

30. An exposure apparatus that synchronously moves a first object and a second object and transfers a pattern of said first object onto said second object, said apparatus comprising:
a stage system that has a first movable body that holds said first object, a second movable body that holds said second object, and a drive system that drives said first movable body and said second movable body independently;
a first interferometer system that irradiates a measurement beam onto a retroreflector provided in said first movable body and measures positional information on a scanning direction of said first movable body in which said first object is synchronously moved;
a second interferometer system that measures positional information of said second movable body; and
a control unit that controls said drive system based on measurement results of said first interferometer system and said second interferometer system, and on error information on position measurement of said first movable body due to said retroreflector.

31. The exposure apparatus of claim 30, wherein
said control unit controls said drive system using different error information according to the position of said first movable body in a non-scanning direction orthogonal to said scanning direction.

32. A device manufacturing method including a lithographic process, wherein
in said lithographic process, exposure is performed using the exposure apparatus of claim 16.

33. A device manufacturing method including a lithographic process, wherein
in said lithographic process, exposure is performed using the exposure apparatus of claim 30
